(19) United States
(12) Patent Application Publication
(10) Pub. No.: US 2017/0197426 A1
(43) Pub. Date: Jul. 13, 2017

(54) LIQUID EJECTION PRINTING APPARATUS AND LIQUID EJECTION HEAD

(71) Applicant: CANON KABUSHIKI KAISHA, Tokyo (JP)

(72) Inventors: Noriyasu Nagai, Tokyo (JP); Shuzo Iwanaga, Kawasaki-shi (JP); Seiichiro Karita, Saitama-shi (JP); Kazuhiro Yamada, Yokohama-shi (JP); Akira Yamamoto, Yokohama-shi (JP); Takatsuna Aoki, Yokohama-shi (JP); Shingo Okushima, Kawasaki-shi (JP); Akio Saito, Machida-shi (JP); Zentaro Tamenaga, Sagamihara-shi (JP); Tatsurou Mori, Yokohama-shi (JP)

(21) Appl. No.: 15/380,584

(22) Filed: Dec. 15, 2016

(30) Foreign Application Priority Data
Jan. 8, 2016 (JP) 2016-003086

(51) Int. Cl. B41J 2/175

(52) U.S. Cl. CPC B41J 2/17563

(57) ABSTRACT

A liquid ejection printing apparatus includes a pressure control assembly that generates a pressure for causing the same liquid to flow to the ejection opening communication passage communicating with an ejection opening of a liquid ejection head. The pressure control assembly includes a first pressure adjustment mechanism that causes a liquid supplied from a first upstream passage to flow therefrom at a first pressure and a second pressure adjustment mechanism that causes a liquid supplied from a second upstream passage therefrom at a second pressure different from the first pressure. The first upstream passage and the second upstream passage communicate with each other and a first downstream passage communicating with the first pressure adjustment mechanism and a second downstream passage communicating with the second pressure adjustment mechanism are respectively connected to the same ejection opening communication passage communicating with the ejection opening.

### BACKGROUND OF THE INVENTION

Field of the Invention

The present invention relates to a liquid ejection printing apparatus and a liquid ejection head that print an image by ejecting a liquid from an ejection opening formed at the liquid ejection head.

Description of the Related Art

In a liquid ejection printing apparatus that prints an image by ejecting a liquid such as ink, there is a need to form a meniscus within an ejection opening of a liquid ejection head in a non-liquid ejection state in order to appropriately eject the liquid. For that reason, the pressures of the ejection opening and a passage communicating with the ejection opening are kept at a negative pressure by a negative pressure generation source connected to the liquid ejection head. Here, in a case where the negative pressure applied from the negative pressure generation source changes, a position of the meniscus within the ejection opening changes and thus a volume of an ejected liquid droplet also changes. In a case where a change degree is large, concentration unevenness occurs in a printed image and thus quality is influenced.

Here, International Laid-Open No. 2005/075202 discloses a technology of controlling a negative pressure applied to an ejection opening using a pressure control unit in order to stabilize a position of a meniscus within the ejection opening. In International Laid-Open No. 2005/075202, a unit having two pressure adjustment mechanisms is assembled to a liquid supply path to a head and different kinds of liquids are controlled at different pressures by the pressure adjustment mechanisms so that the positions of the meniscuses within the ejection openings for different liquids are stabilized.

Further, Japanese Patent Laid-Open No. 2014-141032 discloses a technology of causing ink inside an ejection opening of a print element board to flow by generating a differential pressure between an ink supply side passage and an ink collection side passage while the ejection opening communicates with the ink supply side passage and the ink collection side passage.

In the pressure adjustment mechanism disclosed in International Laid-Open No. 2005/075202, there is a need to pressurize the pressure adjustment mechanism in order to control the pressure and to suppress a change in pressure applied to the pressure adjustment mechanism in order to improve the pressure adjustment accuracy.

Further, in the technology disclosed in Japanese Patent Laid-Open No. 2014-141032, a supply side pressure adjustment unit connected to the ink supply side passage and a collection side pressure adjustment unit connected to the ink collection side passage are respectively connected to a supply side pump and a collection side pump through independent passages. For this reason, the pressure applied to the supply side pressure adjustment unit and the pressure applied to the collection side pressure adjustment unit are apt to largely change and thus a differential pressure between the pressures of the supply side passage and the collection side passage largely changes. In this way, in a case where the differential pressure changes, a flow rate of a fluid flowing through the liquid ejection head changes and thus image quality is deteriorated. That is, in a case where the flow rate of the ink flowing through the liquid ejection head changes, the evaporation amount of a solvent from the ejection opening changes. As a result, a color concentration in the ink changes and the amount of a coloring material included in the ejected ink droplet becomes uneven. Further, the amount of exhaust heat from the ejection opening changes. As a result, the viscosity of the ink changes and the volume of the ejected ink droplet becomes uneven. In the event of such a phenomenon, concentration unevenness occurs in a printed image and thus image quality is deteriorated.

### SUMMARY OF THE INVENTION

An object of the invention is to provide a liquid ejection printing apparatus capable of stabilizing a flow rate of a liquid flowing through an ejection opening communication passage communicating with an ejection opening by generating a stable differential pressure between two pressure adjustment mechanisms while suppressing a change in pressure applied thereto.

According to the invention, there is provided a liquid ejection printing apparatus that performs printing by ejecting a liquid from an ejection opening formed in a liquid ejection head, the liquid ejection printing apparatus comprising: a pressure control assembly that generates a pressure for causing a liquid to flow to an ejection opening communication passage communicating with the ejection opening, wherein the pressure control assembly includes: a first upstream passage, a first pressure adjustment mechanism that causes a liquid supplied from a first upstream passage to flow therefrom at a first pressure, and a second upstream passage, a second pressure adjustment mechanism that causes a liquid supplied from a second upstream passage to flow therefrom at a second pressure different from the first pressure, a first downstream passage that supplies a liquid to the ejection opening communication passage from the first pressure adjustment mechanism, a second downstream passage that supplies a liquid to the ejection opening communication passage from the second pressure adjustment mechanism, wherein the first upstream passage and the second upstream passage communicate with each other, and wherein the first downstream passage and the second downstream passage are respectively connected to the same ejection opening communication passage.

According to the liquid ejection printing apparatus of the invention, it is possible to generate a stable differential pressure between two pressure adjustment mechanisms while suppressing a change in pressure applied thereto. For this reason, since the flow rate of the liquid flowing through the ejection opening communication passage communicating with the ejection opening can be stabilized, it is possible to realize a high-quality image printing operation while suppressing concentration unevenness.

Further features of the present invention will become apparent from the following description of exemplary embodiments (with reference to the attached drawings).

### BRIEF DESCRIPTION OF THE DRAWINGS

FIG. 1 is a diagram illustrating a schematic configuration of a liquid ejection printing apparatus;

FIG. 2 is a schematic diagram illustrating a first circulation configuration in a circulation path applied to a printing apparatus;

FIG. 3 is a schematic diagram illustrating a schematic configuration of a pressure control assembly according to the embodiment;

FIGS. 4A and 4B are perspective views illustrating a schematic configuration of a liquid ejection head;

FIG. 5 is an exploded perspective view illustrating components or units constituting the liquid ejection head;

FIG. 6 is a diagram illustrating front and rear faces of first to third passage members;

FIG. 7 is an enlarged perspective view illustrating a part α of the portion (a) in FIG. 6;

FIG. 8 is a cross-sectional view taken along a line VIII-VIII of FIG. 7;

FIG. 9A is schematic views illustrating ejection module;

FIG. 9B is an exploded view illustrating an ejection module illustrated in FIG. 9A;

FIGS. 10A to 10C are perspective views illustrating a print element board;

FIG. 11 is a perspective view illustrating cross-sections of a print element board and a cover plate taken along a line XI-XI of FIG. 10A;

FIG. 12 is a partially enlarged top view illustrating adjacent portions of print element boards between two adjacent ejection modules;

FIG. 13 is a perspective view illustrating a schematic configuration of a negative pressure control unit according to the embodiment;

FIGS. 14A and 14B are cross-sectional views taken along a line XIV-XIV of FIG. 13;

FIG. 15 is a diagram illustrating a relation between a passage resistance of a valve portion and an opening degree of a valve body;

FIG. 16 is a diagram illustrating a negative pressure control unit 230A according to a first example;

FIG. 17 is a cross-sectional view illustrating a negative pressure control unit 230B according to a second example;

FIG. 18 is a cross-sectional view illustrating a negative pressure control unit 230C according to a third example;

FIG. 19 is a cross-sectional view illustrating a negative pressure control unit 230D according to a fourth example;

FIG. 20 is a cross-sectional view illustrating a negative pressure control unit 230E according to a fifth example;

FIG. 21A is a cross-sectional view illustrating a negative pressure control unit 230F according to a sixth example;

FIG. 21B is an enlarged perspective view illustrating a part β indicated by in FIG. 21A;

FIG. 22A is a schematic diagram illustrating a seventh example;

FIG. 22B is a schematic diagram illustrating an eighth example;

FIG. 23A is a schematic diagram illustrating a fluid circuit according to the seventh example;

FIG. 23B is a schematic diagram illustrating a fluid circuit according to the eighth example;

FIG. 23C is a schematic diagram illustrating a fluid circuit according to a comparative example;

FIG. 24 is a diagram illustrating a result obtained by calculating the pressure loss of each of components illustrated in FIGS. 23A to 23C;

FIG. 25A is a diagram illustrating a maximal value and a minimal value of a pressure control value and a control pressure design value of the fluid circuit illustrated in FIG. 23A;

FIG. 25B is a diagram illustrating a maximal value and a minimal value of a pressure control value and a control pressure design value of the fluid circuit illustrated in FIG. 23B;

FIG. 25C is a diagram illustrating a maximal value and a minimal value of a pressure control value and a control pressure design value of the fluid circuit illustrated in FIG. 23C;

FIG. 26A is a diagram illustrating a relation between a flow rate and a differential pressure of a pressure control value of the fluid circuit illustrated in FIG. 23A;

FIG. 26B is a diagram illustrating a relation between a flow rate and a differential pressure of a pressure control value of the fluid circuit illustrated in FIG. 23B;

FIG. 26C is a diagram illustrating a relation between a flow rate and a differential pressure of a pressure control value of the fluid circuit illustrated in FIG. 23C;

FIG. 27A is a schematic diagram illustrating a first modified example of the filter accommodation chamber illustrated in FIG. 3; and

FIG. 27B is a schematic diagram illustrating a second modified example of the filter accommodation chamber illustrated in FIG. 3.

### DESCRIPTION OF THE EMBODIMENTS

Hereinafter, a first embodiment of the invention will be described with reference to the drawings.

### First Embodiment

### (Description of Inkjet Printing Apparatus)

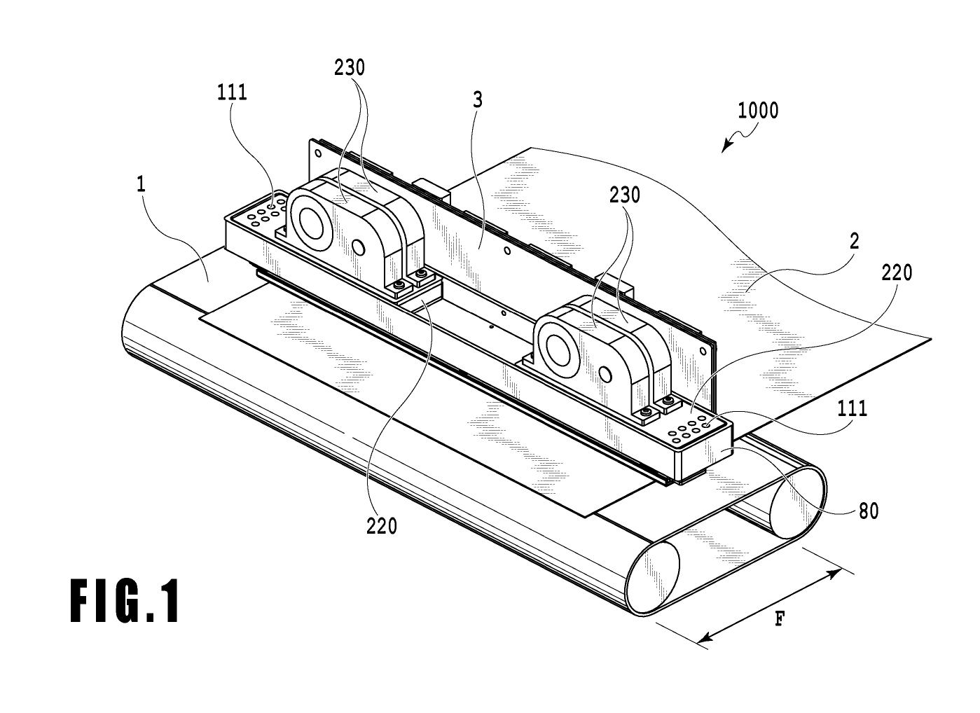

FIG. 1 is a diagram illustrating a schematic configuration of a liquid ejection apparatus that ejects a liquid in the invention and particularly an inkjet printing apparatus (hereinafter, also referred to as a printing apparatus) 1000 that prints an image by ejecting ink. The printing apparatus 1000 includes a conveying unit 1 which conveys a print medium 2 and a line type (page wide type) liquid ejection head 3 which is disposed to be substantially orthogonal to the conveying direction of the print medium 2. Then, the printing apparatus 1000 is a line type printing apparatus which continuously prints an image at one pass by ejecting ink onto the relative moving print mediums 2 while continuously or intermittently conveying the print mediums 2. The liquid ejection head 3 includes a negative pressure control unit 230 which controls a pressure (a negative pressure) inside a circulation path, a liquid supply unit 220 which communicates with the negative pressure control unit 230 so that a fluid can flow therebetween, a liquid connection portion 111 which serves as an ink supply opening and an ink discharge opening for supplying to the liquid supply unit 220, and a casing 80. The print medium 2 is not limited to a cut sheet and may be also a continuous roll medium.

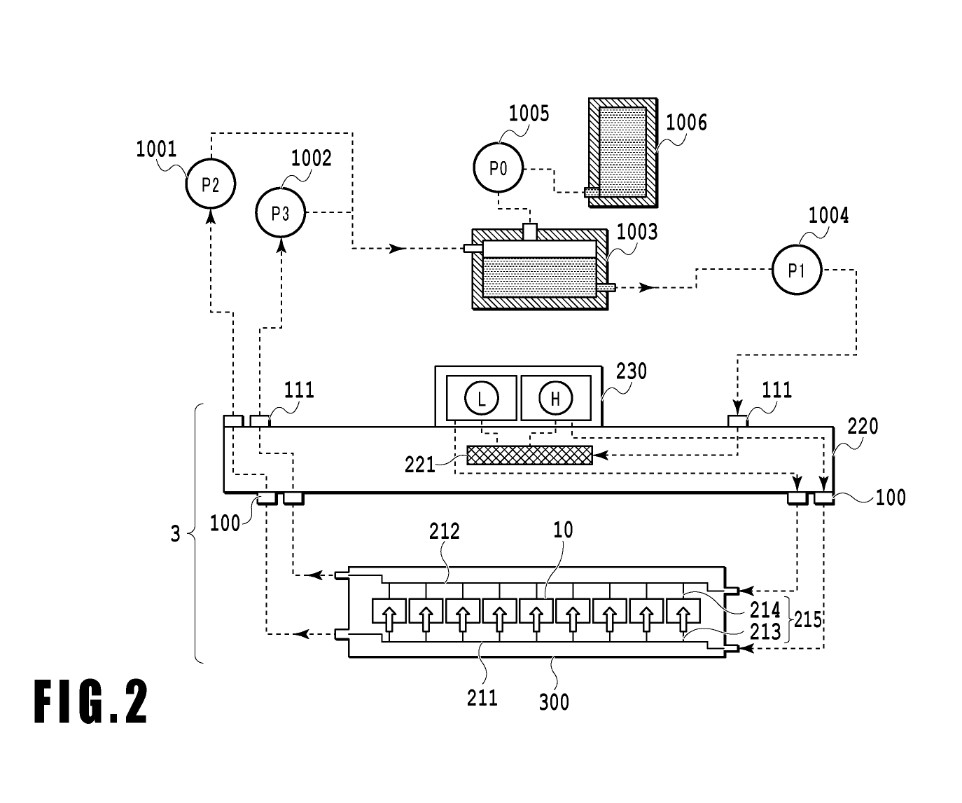

The liquid ejection head 3 can print a full color image by inks of cyan C, magenta M, yellow Y, and black K and is fluid-connected to a liquid supply member which serve as a supply path supplying a liquid to the liquid ejection head 3, a main tank, and a buffer tank (see FIG. 2 to be described later). Further, the control unit which supplies power and transmits an ejection control signal to the liquid ejection head 3 is electrically connected to the liquid ejection head 3. The liquid path and the electric signal path in the liquid ejection head 3 will be described later.

The printing apparatus 1000 is an inkjet printing apparatus that circulates a liquid such as ink between a tank to be described later and the liquid ejection head 3. The circulation configuration includes a first circulation configuration in which the liquid is circulated by the activation of two circulation pumps (for high and low pressures) at the downstream side of the liquid ejection head 3 and a second circulation configuration in which the liquid is circulated by the activation of two circulation pumps (for high and low pressures) at the upstream side of the liquid ejection head 3. Hereinafter, the first circulation configuration and the second circulation configuration of the circulation will be described.

### (Description of First Circulation Configuration)

FIG. 2 is a schematic diagram illustrating the first circulation configuration in the circulation path applied to the printing apparatus 1000 of the present embodiment. The liquid ejection head 3 is fluid-connected to a first circulation pump (the high pressure side) 1001, a first circulation pump (the low pressure side) 1002, and a buffer tank 1003. Further, in FIG. 2, in order to simplify a description, a path through which ink of one color of cyan C, magenta M, yellow Y, and black K flows is illustrated. However, in fact, four colors of circulation paths are provided in the liquid ejection head 3 and the printing apparatus body.

In the circulation configuration, ink inside a main tank 1006 is supplied into the buffer tank 1003 by a replenishing pump 1005 and then is supplied to the liquid supply unit 220 of the liquid ejection head 3 through the liquid connection portion 111 by a second circulation pump 1004. Subsequently, the ink which is adjusted to two different negative pressures (high and low pressures) by the negative pressure control unit 230 connected to the liquid supply unit 220 is circulated while being divided into two passages having the high and low pressures. The ink inside the liquid ejection head 3 is circulated in the liquid ejection head by the actions of the first circulation pump (the high pressure side) 1001 and the first circulation pump (the low pressure side) 1002 at the downstream side of the liquid ejection head 3, is discharged from the liquid ejection head 3 through the liquid connection portion 111, and is returned to the buffer tank 1003.

The buffer tank 1003 which is a sub-tank includes an atmosphere communication opening (not illustrated) which is connected to the main tank 1006 to communicate the inside of the tank with the outside and thus can discharge bubbles inside the ink to the outside. The replenishing pump 1005 is provided between the buffer tank 1003 and the main tank 1006. The replenishing pump 1005 delivers the ink from the main tank 1006 to the buffer tank 1003 after the ink is consumed by the ejection (the discharge) of the ink from the ejection opening of the liquid ejection head 3 in the printing operation and the suction collection operation.

Two first circulation pumps 1001 and 1002 draw the liquid from the liquid connection portion 111 of the liquid ejection head 3 so that the liquid flows to the buffer tank 1003. As the first circulation pump, a displacement pump having quantitative liquid delivery ability is desirable. Specifically, a tube pump, a gear pump, a diaphragm pump, and a syringe pump can be exemplified. However, for example, a general constant flow valve or a general relief valve may be disposed at an outlet of a pump to ensure a predetermined flow rate. When the liquid ejection head 3 is driven, the first circulation pump (the high pressure side) 1001 and the first circulation pump (the low pressure side) 1002 are operated so that the ink flows at a predetermined flow rate through a common supply passage 211 and a common collection passage 212. Since the ink flows in this way, the temperature of the liquid ejection head 3 during a printing operation is kept at an optimal temperature. The predetermined flow rate when the liquid ejection head 3 is driven is desirably set to be equal to or higher than a flow rate at which a difference in temperature among the print element boards 10 inside the liquid ejection head 3 does not influence printing quality.

Above all, when a too high flow rate is set, a difference in negative pressure among the print element boards 10 increases due to the influence of pressure loss of the passage inside a liquid ejection unit 300 and thus unevenness in density of an image is caused. For that reason, it is desirable to set the flow rate in consideration of a difference in temperature and a difference in negative pressure among the print element boards 10.

The negative pressure control unit 230 is provided in a path between the second circulation pump 1004 and the liquid ejection unit 300. The negative pressure control unit 230 is operated to keep a pressure at the downstream side (that is, a pressure near the liquid ejection unit 300) of the negative pressure control unit 230 at a predetermined pressure even when the flow rate of the ink changes in the circulation system due to a difference in ejection amount per unit area. As two negative pressure control mechanisms constituting the negative pressure control unit 230, any mechanism may be used as long as a pressure at the downstream side of the negative pressure control unit 230 can be controlled within a predetermined range having a desired set pressure as its center.

As an example, a mechanism such as a so-called “pressure reduction regulator” can be employed. In the circulation passage of the application example, the upstream side of the negative pressure control unit 230 is pressurized by the second circulation pump 1004 through the liquid supply unit 220. With such a configuration, since an influence of a water head pressure of the buffer tank 1003 with respect to the liquid ejection head 3 can be suppressed, a degree of freedom in layout of the buffer tank 1003 of the printing apparatus 1000 can be widened.

As the second circulation pump 1004, a turbo pump or a displacement pump can be used as long as a predetermined head pressure or more can be exhibited in the range of the ink circulation flow rate used when the liquid ejection head 3 is driven. Specifically, a diaphragm pump can be used. Further, for example, a water head tank disposed to have a certain water head difference with respect to the negative pressure control unit 230 can be also used instead of the second circulation pump 1004. As illustrated in FIG. 2, the negative pressure control unit 230 includes two negative pressure adjustment mechanisms respectively having different control pressures. Among two negative pressure adjustment mechanisms, a relatively high pressure side (indicated by “H” in FIG. 2) and a relatively low pressure side (indicated by “L” in FIG. 2) are respectively connected to the common supply passage 211 and the common collection passage 212 inside the liquid ejection unit 300 through the liquid supply unit 220.

The liquid ejection unit 300 is provided with the common supply passage 211, the common collection passage 212, and an individual passage 215 (an individual supply passage 213 and an individual collection passage 214) as an ejection communicating passage communicating with the ejection port of the print element board. The negative pressure control mechanism H is connected to the common supply passage 211, the negative pressure control mechanism L is connected to the common collection passage 212, and a differential pressure is formed between two common passages. Then, since the individual passage 215 communicates with the common supply passage 211 and the common collection passage 212, a flow (a flow indicated by an arrow direction of FIG. 2) is generated in which a part of the liquid flows from the common supply passage 211 to the common collection passage 212 through the passage formed inside the print element board 10.

In this way, the liquid ejection unit 300 has a flow in which a part of the liquid passes through the print element boards 10 while the liquid flows to pass through the common supply passage 211 and the common collection passage 212. For this reason, heat generated by the print element boards 10 can be discharged to the outside of the print element board 10 by the ink flowing through the common supply passage 211 and the common collection passage 212. With such a configuration, the flow of the ink can be generated even in the pressure chamber or the ejection opening not ejecting the liquid when an image is printed by the liquid ejection head 3. Accordingly, the thickening of the ink can be suppressed in such a manner that the viscosity of the ink thickened inside the ejection opening is decreased. Further, the thickened ink or the foreign material in the ink can be discharged toward the common collection passage 212. For this reason, the liquid ejection head 3 of the present embodiment can print a high-quality image at a high speed.

In the two pressure adjustment mechanisms arranged in the negative pressure control unit 230 described above, a pressure of each of the outflow openings of the two pressure adjustment mechanisms does not always have to be adjusted to negative pressure, but the pressures are preferably controlled such that the negative pressure is maintained in the ejection openings. In the case where the pressure adjustment mechanisms are arranged at upper positions relative to the ejection openings in the vertical direction, it is preferable that the pressure of the outflow openings of the pressure adjustment mechanisms is controlled to negative pressure. Further, in the case where the pressure adjustment mechanisms are arranged at lower positions relative to the ejection openings in the vertical direction, the pressure of the outflow openings of the pressure adjustment mechanisms may be controlled so as to be positive pressure as long as the pressure of the ejection openings is maintained at negative pressure.

It is preferable to arrange the pressure adjustment mechanisms near the ejection openings because it is necessary to suppress the change of the pressure of a passage from the pressure adjustment mechanisms to the ejection openings in order to precisely control the pressure of the ejection openings. Therefore, it is preferable to configure each of the units as a part of the liquid ejection head 3 by integrating the negative pressure control unit 230 and the liquid supply unit 220 with the liquid ejection unit 300.

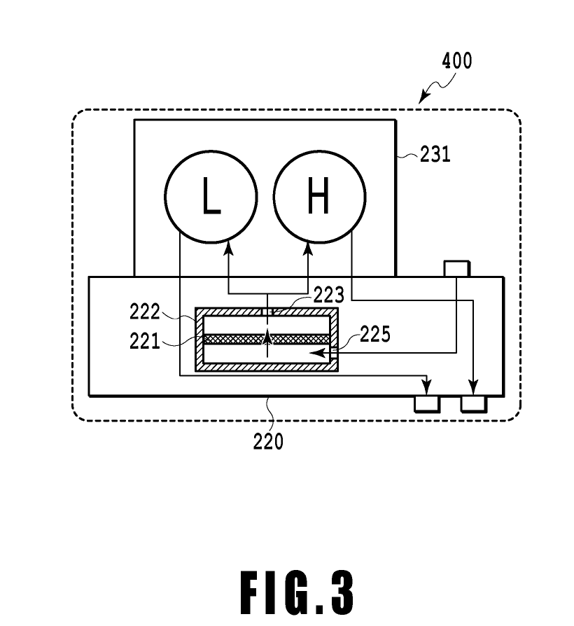

A unit that is configured by combining the negative pressure control unit 230 and the liquid supply unit 220 shown in FIG. 3 is called a pressure control assembly 400. In order to realize a high-quality image printing operation, it is necessary to stabilize the ink circulation flow rate of liquid flowing in the print element board 10 by suppressing a change in pressure loss generated in the passage from the two pressure adjustment mechanisms to the ejection openings to maintain a certain differential pressure. Therefore, it is preferable to reduce pressure loss by installing the negative pressure control unit 230 into the liquid ejection head 3 and decreasing the length of the passage from the pressure adjustment mechanisms to the ejection openings. As shown in FIG. 3, in the present embodiment, a filter accommodation chamber 222 in which the filter 221 is accommodated is provided in the liquid supply unit 220.

A liquid connection portion 111 is connected to the inflow opening 225 of the filter accommodation chamber 222 and the pressure control mechanisms L, H are connected to the outflow opening 223. Liquid sent to the liquid supply unit 220 flows from the inflow opening 225 into the filter accommodation chamber 222, and is supplied into the pressure control mechanisms L and H via the outflow openings 223 after foreign objects such as a contamination and a deposit generated from ink are removed from the liquid by the filter 222.

### (Description of a Configuration of the Liquid Ejection Head)

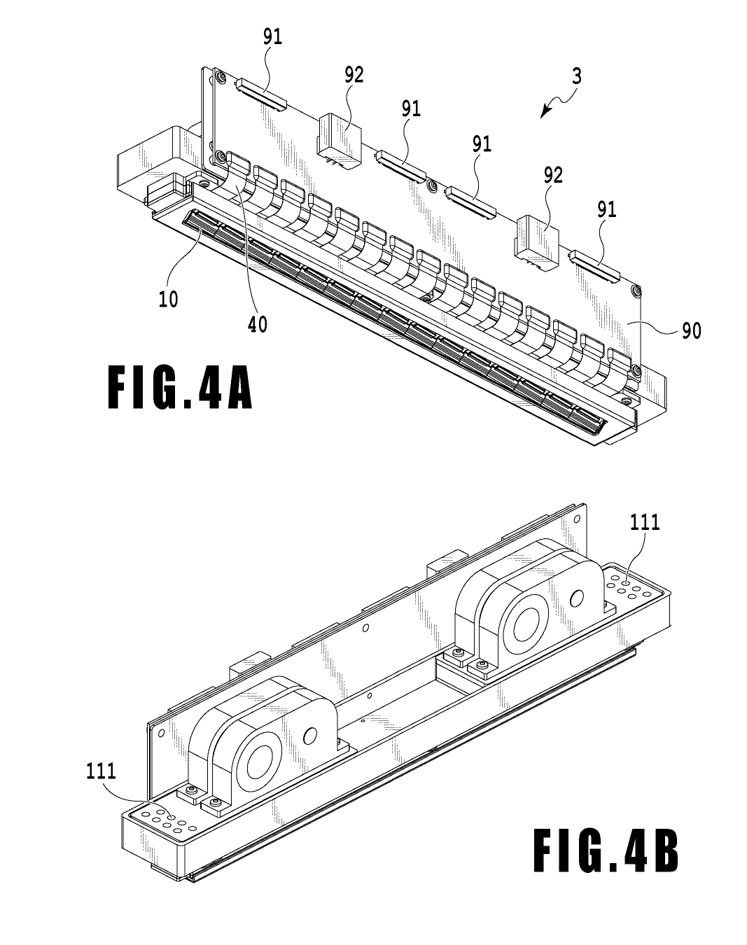

A configuration of the liquid ejection head 3 according to the first embodiment will be described. FIGS. 4A and 4B are perspective views illustrating the liquid ejection head 3 according to the present embodiment. The liquid ejection head 3 is a line type liquid ejection head in which fifteen print element boards 10 capable of ejecting inks of four colors of cyan C, magenta M, yellow Y, and black K are arranged in series on one print element board 10 (an in-line arrangement). As illustrated in FIG. 4A, the liquid ejection head 3 includes the print element boards 10 and a signal input terminal 91 and a power supply terminal 92 which are electrically connected to each other through a flexible circuit board 40 and an electric wiring board 90 capable of supplying electric energy to the print element board 10.

The signal input terminal 91 and the power supply terminal 92 are electrically connected to the control unit of the printing apparatus 1000 so that an ejection drive signal and power necessary for the ejection are supplied to the print element board 10. Since the wirings are integrated by the electric circuit inside the electric wiring board 90, the number of the signal input terminals 91 and the power supply terminals 92 can be decreased compared with the number of the print element boards 10. Accordingly, the number of electrical connection components to be detached when the liquid ejection head 3 is assembled to the printing apparatus 1000 or the liquid ejection head is replaced decreases.

As illustrated in FIG. 4B, the liquid connection portions 111 which are provided at both ends of the liquid ejection head 3 are connected to the liquid supply system of the printing apparatus 1000. Accordingly, the inks of four colors including cyan C, magenta M, yellow Y, and black K4 are supplied from the supply system of the printing apparatus 1000 to the liquid ejection head 3 and the inks passing through the liquid ejection head 3 are collected by the supply system of the printing apparatus 1000. In this way, the inks of different colors can be circulated through the path of the printing apparatus 1000 and the path of the liquid ejection head 3.

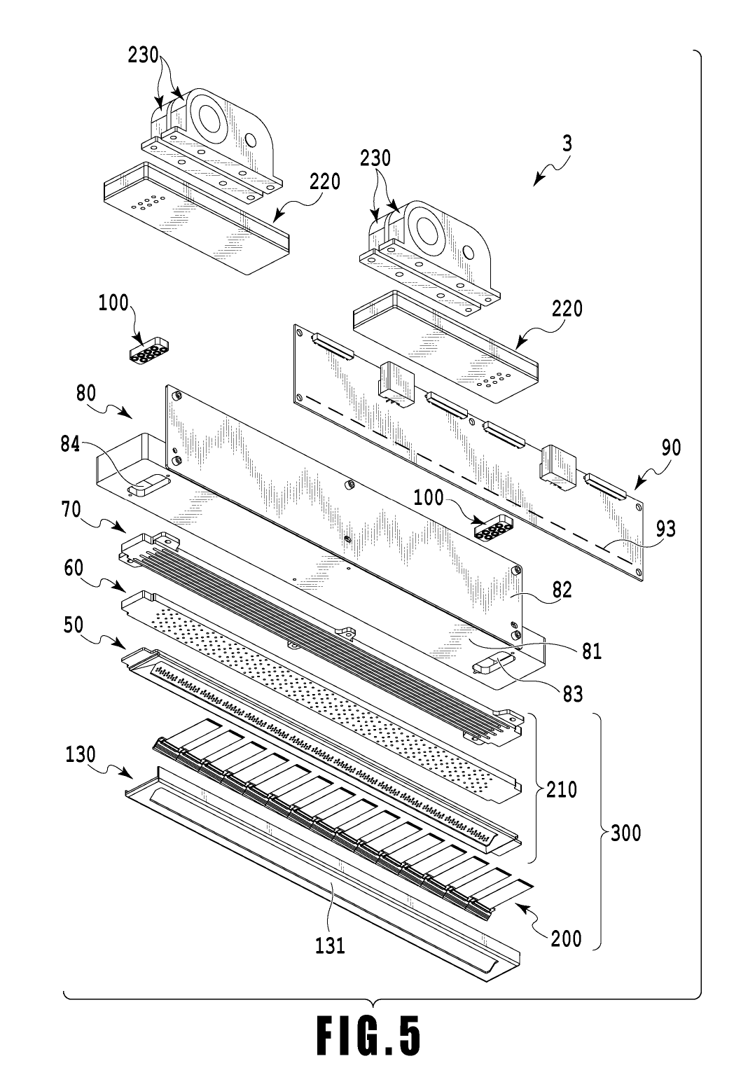

FIG. 5 is an exploded perspective view illustrating components or units constituting the liquid ejection head 3. The liquid ejection unit 300, the liquid supply unit 220, and the electric wiring board 90 are attached to the casing 80. The liquid connection portions 111 (see FIG. 3) are provided in the liquid supply unit 220. Also, in order to remove a foreign material in the supplied ink, filters 221 (see FIGS. 2 and 3) for different colors are provided inside the liquid supply unit 220 while communicating with the openings of the liquid connection portions 111. Two liquid supply units 220 respectively corresponding to two colors are provided with the filters 221. The liquid passing through the filter 221 is supplied to the negative pressure control unit 230 disposed on the liquid supply unit 220 disposed to correspond to each color.

The negative pressure control unit 230 is a unit which includes negative pressure control valves corresponding to different colors. By the function of a spring member or a valve provided therein, a change in pressure loss inside the supply system (the supply system at the upstream side of the liquid ejection head 3) of the printing apparatus 1000 caused by a change in flow rate of the liquid is largely decreased. Accordingly, the negative pressure control unit 230 can stabilize a change of negative pressure at the downstream side (the liquid ejection unit 300) of the negative pressure control unit within a predetermined range. As described in FIG. 2, two negative pressure control valves corresponding to different colors are built inside the negative pressure control unit 230. Two negative pressure control valves are respectively set to different control pressures. Here, the high pressure side communicates with the common supply passage 211 (see FIG. 2) inside the liquid ejection unit 300 and the low pressure side communicates with the common collection passage 212 (see FIG. 2) through the liquid supply unit 220.

The casing 80 includes a liquid ejection unit support portion 81 and an electric wiring board support portion 82 and ensures the rigidity of the liquid ejection head 3 while supporting the liquid ejection unit 300 and the electric wiring board 90. The electric wiring board support portion 82 is used to support the electric wiring board 90 and is fixed to the liquid ejection unit support portion 81 by a screw. The liquid ejection unit support portion 81 is used to correct the warpage or deformation of the liquid ejection unit 300 to ensure the relative position accuracy among the print element boards 10. Accordingly, stripe and unevenness of a printed medium is suppressed.

For that reason, it is desirable that the liquid ejection unit support portion 81 have sufficient rigidity. As a material, metal such as SUS or aluminum, or ceramic such as alumina is desirable. The liquid ejection unit support portion 81 is provided with openings 83 and 84 into which a joint rubber 100 is inserted. The liquid supplied from the liquid supply unit 220 is led to a third passage member 70 constituting the liquid ejection unit 300 through the joint rubber.

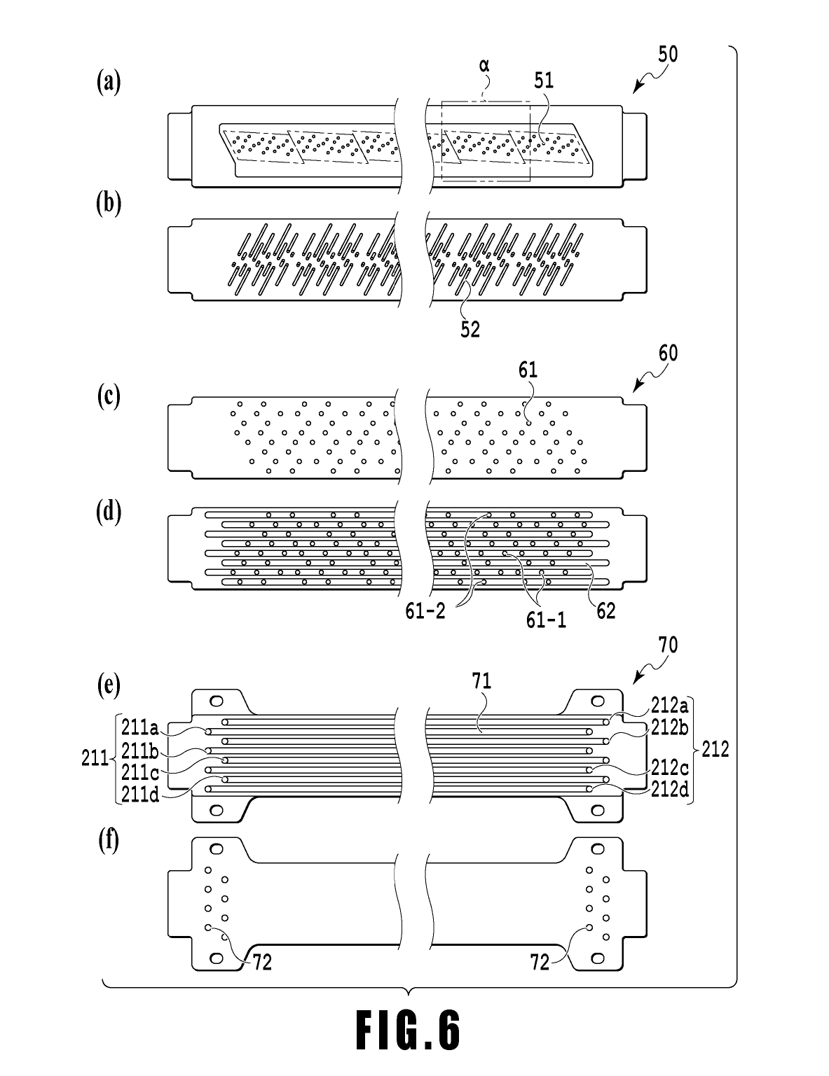

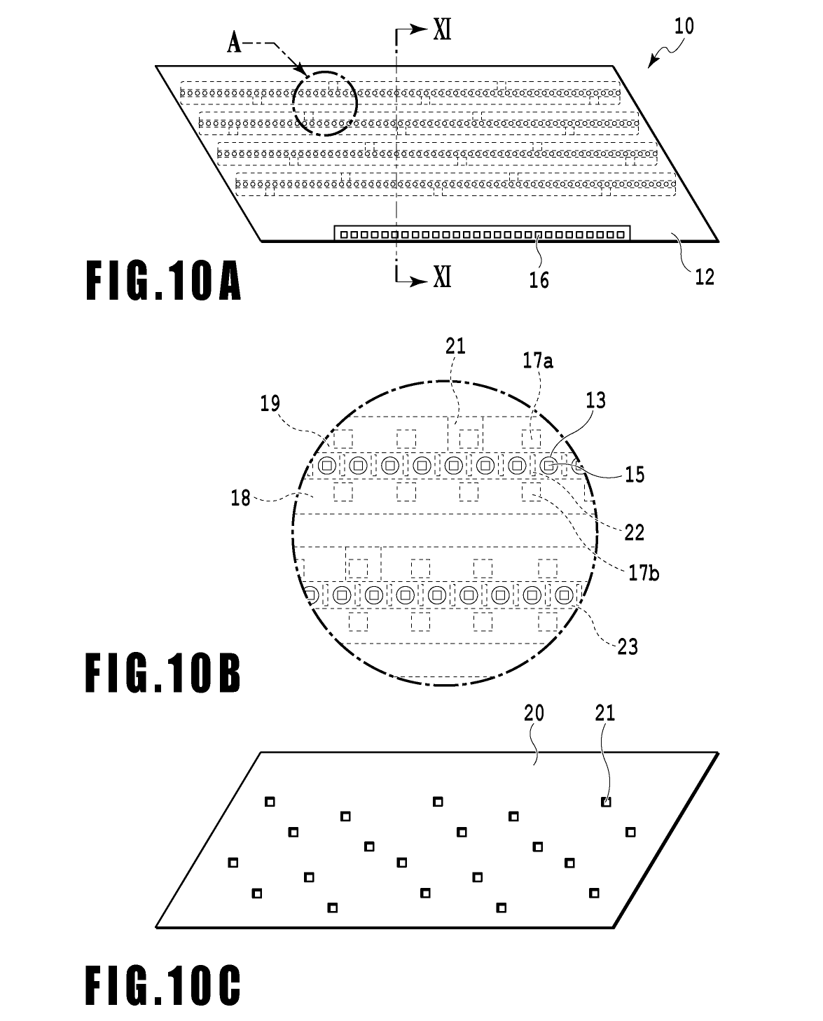

The liquid ejection unit 300 includes a plurality of ejection modules 200 and a passage member 210 and a cover member 130 is attached to a face facing the print medium in the liquid ejection unit 300. Here, the cover member 130 is a member having a picture frame shaped surface and provided with an elongated opening 131 as illustrated in FIG. 6 and the print element board 10 and a sealing member 110 (see FIG. 10A to be described later) included in the ejection module 200 are exposed from the opening 131. A peripheral frame of the opening 131 serves as a contact face of a cap member that caps the liquid ejection head 3 in the print standby state. For this reason, it is desirable to form a closed space in a capping state by applying an adhesive, a sealing material, and a filling material along the periphery of the opening 131 to fill unevenness or a gap on the ejection opening face of the liquid ejection unit 300.

Next, a configuration of the passage member 210 included in the liquid ejection unit 300 will be described. As illustrated in FIG. 6, the passage member 210 is obtained by laminating a first passage member 50, a second passage member 60, and a third passage member 70 and distributes the liquid supplied from the liquid supply unit 220 to the ejection modules 200. Further, the passage member 210 is a passage member that returns the liquid re-circulated from the ejection module 200 to the liquid supply unit 220. The passage member 210 is fixed to the liquid ejection unit support portion 81 by a screw and thus the warpage or deformation of the passage member 210 is suppressed.

Portions (a) to (f) in FIG. 6 are diagrams illustrating front and rear faces of the first to third passage members. The portion (a) in FIG. 6 illustrates a face onto which the ejection module 200 is mounted in the first passage member 50 and the portion (f) in FIG. 6 illustrates a face with which the liquid ejection unit support portion 81 comes into contact in the third passage member 70. The first passage member 50 and the second passage member 60 are bonded to each other so that the portions (b) and (c) in FIG. 6 corresponding to the contact faces of the passage members face each other and the second passage member and the third passage member are bonded to each other so that the portions illustrated in the portions (d) and (e) in FIG. 6 and corresponding to the contact faces of the passage members face each other. When the second passage member 60 and the third passage member 70 are bonded to each other, eight common passages (211a, 211b, 211c, 211d, 212a, 212b, 212c, 212d) extending in the longitudinal direction of the passage member are formed by common passage grooves 62 and 71 of the passage members.

Accordingly, a set of the common supply passage 211 and the common collection passage 212 is formed inside the passage member 210 to correspond to each color. The ink is supplied from the common supply passage 211 to the liquid ejection head 3 and the ink supplied to the liquid ejection head 3 is collected by the common collection passage 212. A communication opening 72 (see the portion (f) in FIG. 6) of the third passage member 70 communicates with the holes of the joint rubber 100 and is fluid-connected to the liquid supply unit 220 (see FIG. 5). A bottom face of the common passage groove 62 of the second passage member 60 is provided with a plurality of communication openings 61 (a communication opening 61-1 communicating with the common supply passage 211 and a communication opening 61-2 communicating with the common collection passage 212) and communicates with one end of an individual passage groove 52 of the first passage member 50. The other end of the individual passage groove 52 of the first passage member 50 is provided with a communication opening 51 and is fluid-connected to the ejection modules 200 through the communication opening 51. By the individual passage groove 52, the passages can be densely provided at the center side of the passage member.

It is desirable that the first to third passage members be formed of a material having corrosion resistance with respect to a liquid and having a low linear expansion coefficient. As a material, for example, a composite material (resin) obtained by adding inorganic filler such as fiber or fine silica particles to a base material such as alumina, LCP (liquid crystal polymer), PPS (polyphenyl sulfide), PSF (polysulfone) can be appropriately used. As a method of forming the passage member 210, three passage members may be laminated and adhered to one another. When a resin composite material is selected as a material, a bonding method using welding may be used.

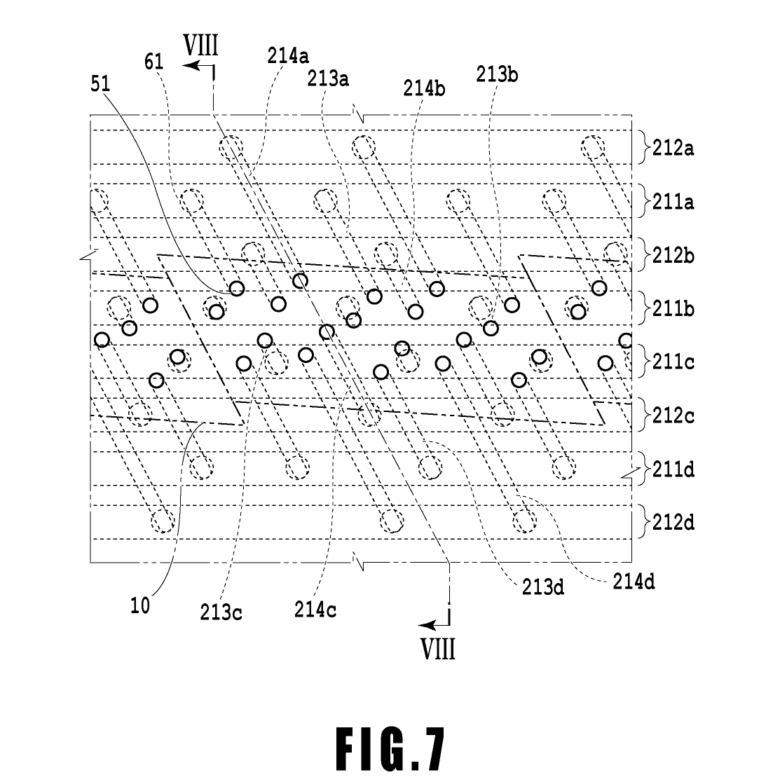

FIG. 7 is a partially enlarged perspective view illustrating a part α of a portion (a) in FIG. 6 and illustrating the passages inside the passage member 210 formed by bonding the first to third passage members to one another when viewed from a face onto which the ejection module 200 is mounted in the first passage member 50. The common supply passage 211 and the common collection passage 212 are formed such that the common supply passage 211 and the common collection passage 212 are alternately disposed from the passages of both ends. Here, a connection relation among the passages inside the passage member 210 will be described.

The passage member 210 is provided with the common supply passage 211 (211a, 211b, 211c, 211d) and the common collection passage 212 (212a, 212b, 212c, 212d) extending in the longitudinal direction of the liquid ejection head 3 and provided for each color. The individual supply passages 213 (213a, 213b, 213c, 213d) which are formed by the individual passage grooves 52 are connected to the common supply passages 211 for different colors through the communication openings 61. Further, the individual collection passages 214 (214a, 214b, 214c, 214d) formed by the individual passage grooves 52 are connected to the common collection passages 212 for different colors through the communication openings 61. With such a passage configuration, the ink can be intensively supplied to the print element board 10 located at the center portion of the passage member from the common supply passages 211 through the individual supply passages 213. Further, the ink can be collected from the print element board 10 to the common collection passages 212 through the individual collection passages 214.

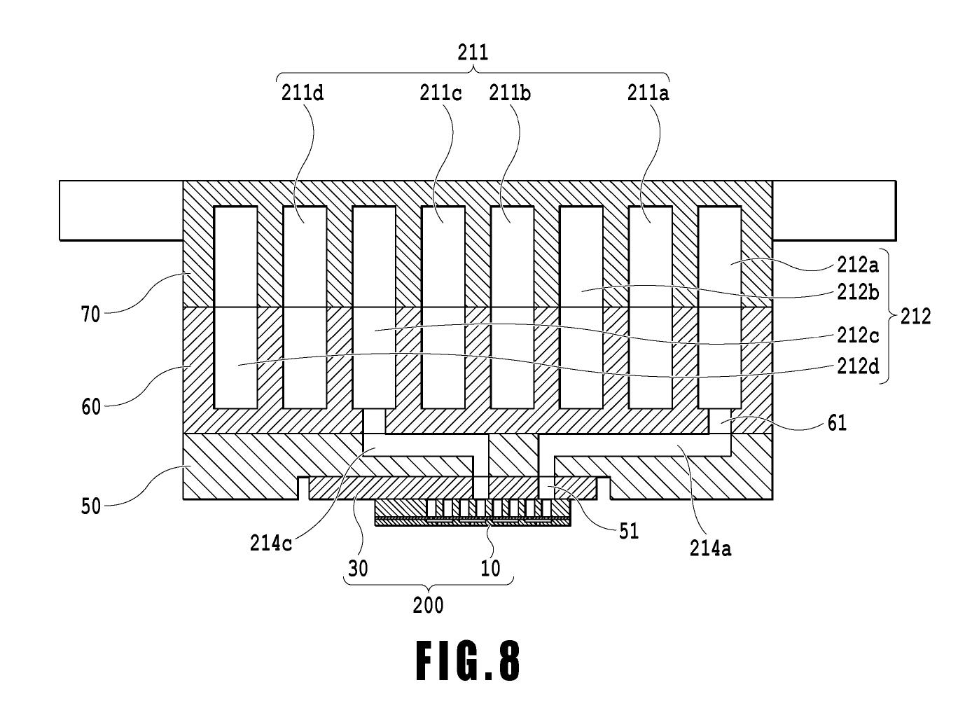

FIG. 8 is a cross-sectional view taken along a line VIII-VIII of FIG. 7. The individual collection passage (214a, 214c) communicates with the ejection module 200 through the communication opening 51. In FIG. 8, only the individual collection passage (214a, 214c) is illustrated, but in a different cross-section, the individual supply passage 213 and the ejection module 200 communicates with each other as illustrated in FIG. 7. A support member 30 and the print element board 10 which are included in each ejection module 200 are provided with passages which supply the ink from the first passage member to a print element 15 provided in the print element board 10. Further, the support member 30 and the print element board 10 are provided with passages which collect (re-circulate) a part or the entirety of the liquid supplied to the print element 15 to the first passage member 50.

Here, the common supply passage 211 of each color is connected to the negative pressure control unit 230 (the high pressure side) of corresponding color through the liquid supply unit 220 and the common collection passage 212 is connected to the negative pressure control unit 230 (the low pressure side) through the liquid supply unit 220. By the negative pressure control unit 230, a differential pressure (a difference in pressure) is generated between the common supply passage 211 and the common collection passage 212. For this reason, as illustrated in FIGS. 7 and 8, a flow is generated in order of the common supply passage 211 of each color, the individual supply passage 213, the print element board 10, the individual collection passage 214, and the common collection passage 212 inside the liquid ejection head of the application example having the passages connected to one another.

### (Description of Ejection Module)

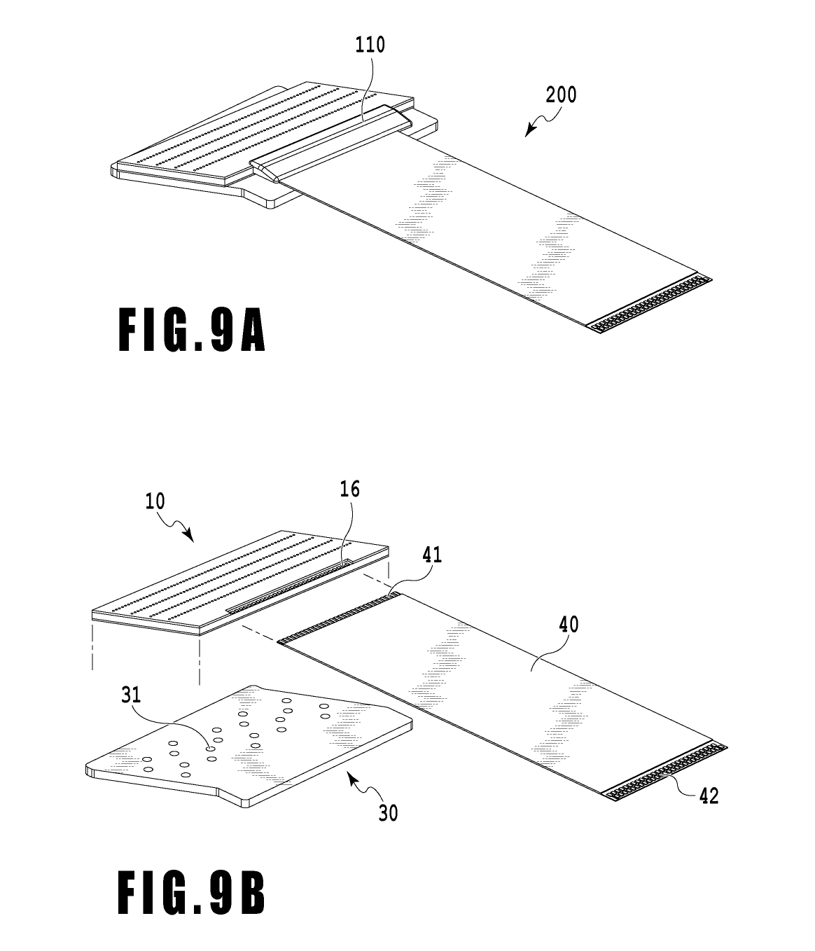

FIG. 9A is a perspective view illustrating one ejection module 200 and FIG. 9B is an exploded view thereof. As a method of manufacturing the ejection module 200, first, the print element board 10 and the flexible circuit board 40 are adhered onto the support member 30 provided with a liquid communication opening 31. Subsequently, a terminal 16 on the print element board 10 and a terminal 41 on the flexible circuit board 40 are electrically connected to each other by wire bonding and the wire bonded portion (the electrical connection portion) is sealed by the sealing member 110.

A terminal 42 which is opposite to the print element board 10 of the flexible circuit board 40 is electrically connected to a connection terminal 93 (see FIG. 5) of the electric wiring board 90. Since the support member 30 serves as a support body that supports the print element board 10 and a passage member that fluid-communicates the print element board 10 and the passage member 210 to each other, it is desirable that the support member have high flatness and sufficiently high reliability while being bonded to the print element board. As a material, for example, alumina or resin is desirable.

### (Description of Structure of Print Element Board)

FIG. 10A is a top view illustrating a face provided with an ejection opening 13 in the print element board 10, FIG. 10B is an enlarged view of a part A of FIG. 10A, and FIG. 10C is a top view illustrating a rear face of FIG. 10A. Here, a configuration of the print element board of the application example will be described. As illustrated in FIG. 10A, an ejection opening forming member of the print element board 10 is provided with four ejection opening arrays corresponding to different colors of inks. Further, the extension direction of the ejection opening arrays of the ejection openings 13 will be referred to as an “ejection opening array direction”. As illustrated in FIG. 10B, the print element 15 serving as an ejection energy generation element for ejecting the liquid by heat energy is disposed at a position corresponding to each ejection opening 13. A pressure chamber 23 provided inside the print element 15 is defined by a partition wall 22.

The print element 15 is electrically connected to the terminal 16 by an electric wire (not illustrated) provided in the print element board 10. Then, the print element 15 boils the liquid while being heated on the basis of a pulse signal input from a control circuit of the printing apparatus 1000 via the electric wiring board 90 (see FIG. 5) and the flexible circuit board 40 (see FIG. 9B). The liquid is ejected from the ejection opening 13 by a foaming force caused by the boiling. As illustrated in FIG. 10B, a liquid supply path 18 extends at one side along each ejection opening array and a liquid collection path 19 extends at the other side along the ejection opening array. The liquid supply path 18 and the liquid collection path 19 are passages that extend in the ejection opening array direction provided in the print element board 10 and communicate with the ejection opening 13 through a supply opening 17a and a collection opening 17b.

As illustrated in FIG. 10C, a sheet-shaped lid member 20 is laminated on a rear face of a face provided with the ejection opening 13 in the print element board 10 and the lid member 20 is provided with a plurality of openings 21 communicating with the liquid supply path 18 and the liquid collection path 19. In the application example, the lid member 20 is provided with three openings 21 for each liquid supply path 18 and two openings 21 for each liquid collection path 19. As illustrated in FIG. 10B, openings 21 of the lid member 20 communicate with the communication openings 51 illustrated in the portion (a) in FIG. 6, respectively.

It is desirable that the lid member 20 have sufficient corrosion resistance for the liquid. From the viewpoint of preventing mixed color, the opening shape and the opening position of the opening 21 need to have high accuracy. For this reason, it is desirable to form the opening 21 by using a photosensitive resin material or a silicon plate as a material of the lid member 20 through photolithography. In this way, the lid member 20 changes the pitch of the passages by the opening 21. Here, it is desirable to form the lid member by a film-shaped member with a thin thickness in consideration of pressure loss.

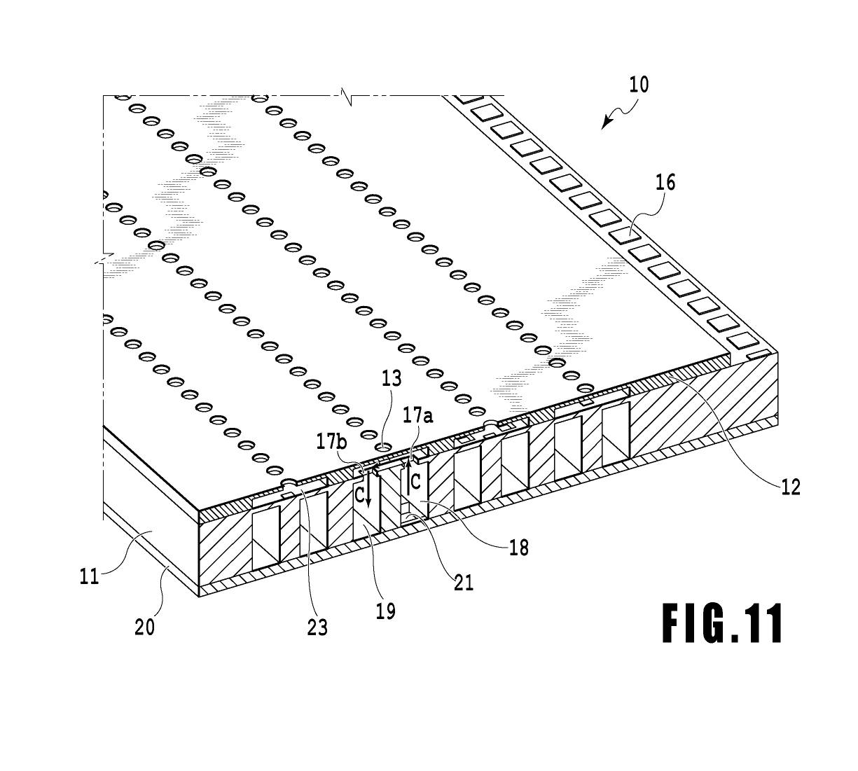

FIG. 11 is a perspective view illustrating cross-sections of the print element board 10 and the lid member 20 when taken along a line XI-XI of FIG. 10A. Here, a flow of the liquid inside the print element board 10 will be described. The lid member 20 serves as a lid that forms a part of walls of the liquid supply path 18 and the liquid collection path 19 formed in a substrate 11 of the print element board 10. The print element board 10 is formed by laminating the substrate 11 formed of Si and the ejection opening forming member 12 formed of photosensitive resin and the lid member 20 is bonded to a rear face of the substrate 11. One face of the substrate 11 is provided with the print element 15 (see FIG. 10B) and a rear face thereof is provided with grooves forming the liquid supply path 18 and the liquid collection path 19 extending along the ejection opening array.

The liquid supply path 18 and the liquid collection path 19 which are formed by the substrate 11 and the lid member 20 are respectively connected to the common supply passage 211 and the common collection passage 212 inside each passage member 210 and a differential pressure is generated between the liquid supply path 18 and the liquid collection path 19. When the liquid is ejected from the ejection opening 13 to print an image, the liquid inside the liquid supply path 18 provided inside the substrate 11 at the ejection opening not ejecting the liquid flows toward the liquid collection path 19 through the supply opening 17a, the pressure chamber 23, and the collection opening 17b by the differential pressure (see an arrow C of FIG. 11). By the flow, foreign materials, bubbles, and thickened ink produced by the evaporation from the ejection opening 13 in the ejection opening 13 or the pressure chamber 23 not involved with a printing operation can be collected by the liquid collection path 19. Further, the thickening of the ink of the ejection opening 13 or the pressure chamber 23 can be suppressed.

The liquid which is collected to the liquid collection path 19 is collected in order of the communication opening 51 inside the passage member 210, the individual collection passage 214, and the common collection passage 212 through the opening 21 of the lid member 20 and the liquid communication opening 31 (see FIG. 9B) of the support member 30. Then, the liquid is collected by the collection path of the printing apparatus 1000. That is, the liquid supplied from the printing apparatus body to the liquid ejection head 3 flows in the following order to be supplied and collected.

First, the liquid flows from the liquid connection portion 111 of the liquid supply unit 220 into the liquid ejection head 3. Then, the liquid is sequentially supplied through the joint rubber 100, the communication opening 72 and the common passage groove 71 provided in the third passage member, the common passage groove 62 and the communication opening 61 provided in the second passage member, and the individual passage groove 52 and the communication opening 51 provided in the first passage member. Subsequently, the liquid is supplied to the pressure chamber 23 while sequentially passing through the liquid communication opening 31 provided in the support member 30, the opening 21 provided in the lid member 20, and the liquid supply path 18 and the supply opening 17a provided in the substrate 11. Subsequently, the liquid is supplied to the pressure chamber 23 while sequentially passing through the liquid communication opening 31 provided at the support member 30, the opening 21 provided at the cover plate 20, and the liquid supply path 18 and the supply opening 17a provided at the substrate 11.

In the liquid supplied to the pressure chamber 23, the liquid which is not ejected from the ejection opening 13 sequentially flows through the collection opening 17b and the liquid collection path 19 provided in the substrate 11, the opening 21 provided in the lid member 20, and the liquid communication opening 31 provided in the support member 30. Subsequently, the liquid sequentially flows through the communication opening 51 and the individual passage groove 52 provided in the first passage member, the communication opening 61 and the common passage groove 62 provided in the second passage member, the common passage groove 71 and the communication opening 72 provided in the third passage member 70, and the joint rubber 100. Then, the liquid flows from the liquid connection portion 111 provided in the liquid supply unit 220 to the outside of the liquid ejection head 3.

In the first circulation configuration illustrated in FIG. 2, the liquid which flows from the liquid connection portion 111 is supplied to the joint rubber 100 through the negative pressure control unit 230. The entire liquid which flows from one end of the common supply passage 211 of the liquid ejection unit 300 is not supplied to the pressure chamber 23 through the individual supply passage 213.

That is, the liquid may flow from the other end of the common supply passage 211 to the liquid supply unit 220 while not flowing into the individual supply passage 213a by the liquid which flows from one end of the common supply passage 211. In this way, since the path is provided so that the liquid flows therethrough without passing through the print element board 10, the reverse flow of the circulation flow of the liquid can be suppressed even in the print element board 10 including the small passage with a high flow resistance as in the application example. In this way, since the thickening of the liquid in the vicinity of the ejection opening or the pressure chamber 23 can be suppressed in the liquid ejection head 3 of the present embodiment, a slippage or a non-ejection can be suppressed. As a result, a high-quality image can be printed.

### (Description of Positional Relation Among Print Element Boards)

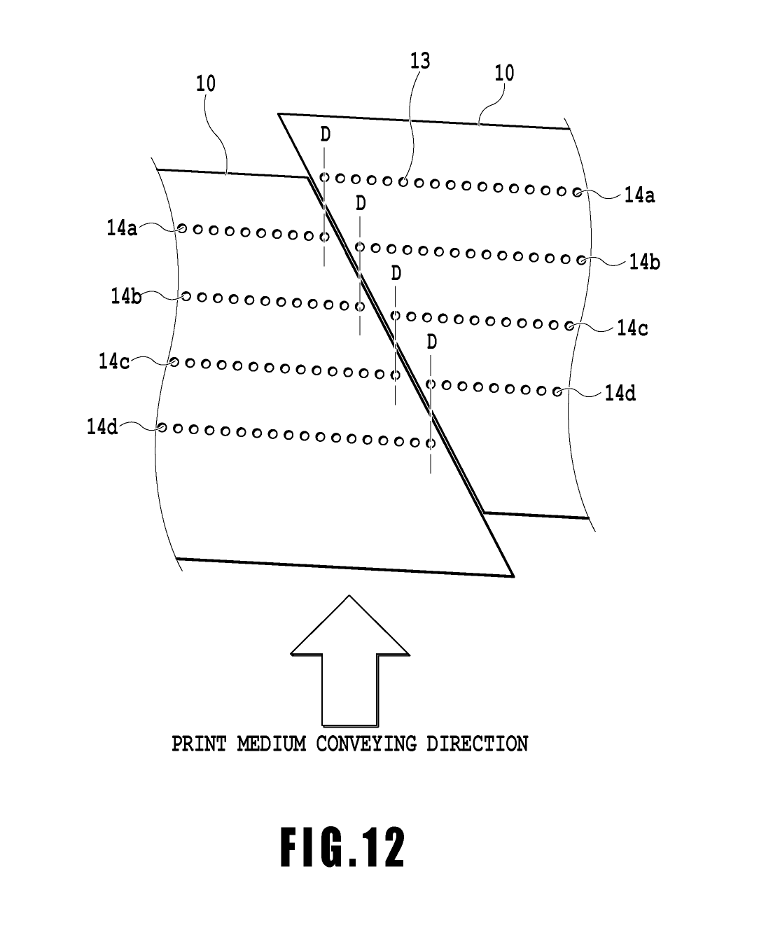

FIG. 12 is a partially enlarged top view illustrating an adjacent portion of the print element board in two adjacent ejection modules. In the present embodiment, a substantially parallelogram print element board is used. Ejection opening arrays (14a to 14d) having the ejection openings 13 arranged in each print element board 10 are disposed to be inclined while having a predetermined angle with respect to the longitudinal direction of the liquid ejection head 3. Then, the ejection opening array at the adjacent portion between the print element boards 10 is formed such that at least one ejection opening overlaps in the print medium conveying direction. In FIG. 12, two ejection openings on a line D overlap each other.

With such an arrangement, even in a case where the position of the print element board 10 is slightly deviated from a predetermined position, black stripes or voids of a printed image cannot be visually recognized by a driving control of the overlapping ejection openings. Even in a case were the plurality of print element boards 10 are arranged in a linear shape (an in-line shape) instead of a stagger arrangement shape, it is possible to prepare a countermeasure for black stripes or voids at the connection portion between the print element boards 10 while suppressing an increase in length of the liquid ejection head 10 in the print medium conveying direction by the configuration illustrated in FIG. 12. Additionally, in the embodiment, the principal plane of the print element board is formed in a parallelogram shape, but the invention is not limited thereto. For example, even in a case where the print element board having a rectangular shape, a trapezoid shape, or the other shapes is used, the configuration of the invention can be desirably applied thereto.

### (Description of Negative Pressure Control Unit)

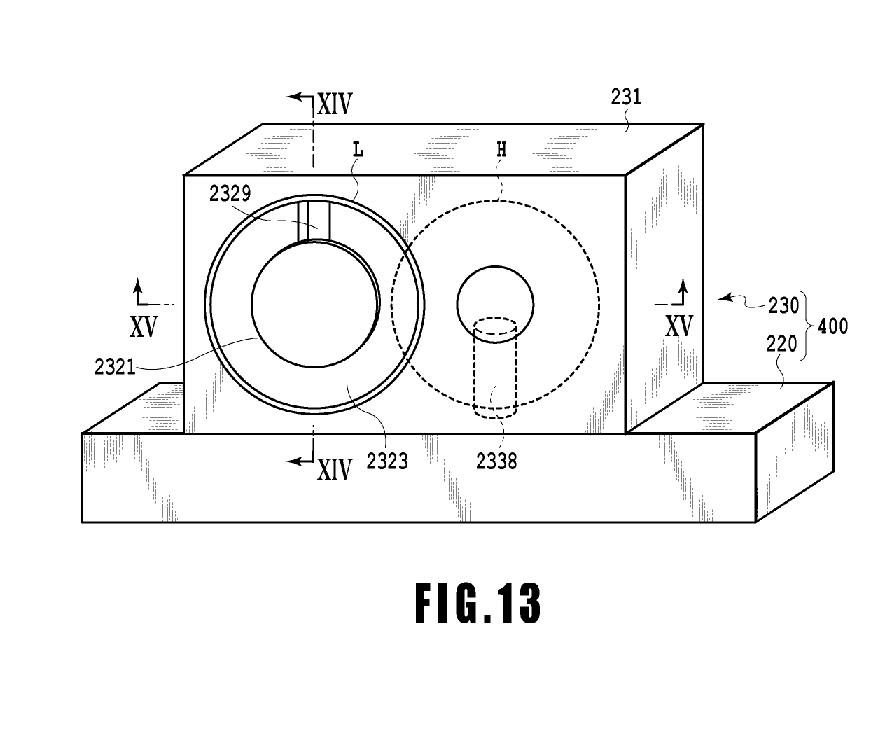

FIG. 13 is a perspective view illustrating a schematic configuration of the negative pressure control unit 230 according to the first embodiment of the invention. The negative pressure control unit 230 is provided with a negative pressure control unit casing 231 and two pressure adjustment mechanisms L and H provided inside the negative pressure control unit casing 231. A liquid (ink) is supplied from a pump 104 illustrated in FIG. 2 into two pressure adjustment mechanisms L and H through a filter 221 and the like. After the pressure of the liquid flowing from the upstream side is adjusted to a different pressure (a different negative pressure) in the negative pressure control unit 230, the liquid is supplied to a liquid ejection head at a rear stage. Hereinafter, the configurations and the effects of the pressure adjustment mechanisms L and H will be described in more detail.

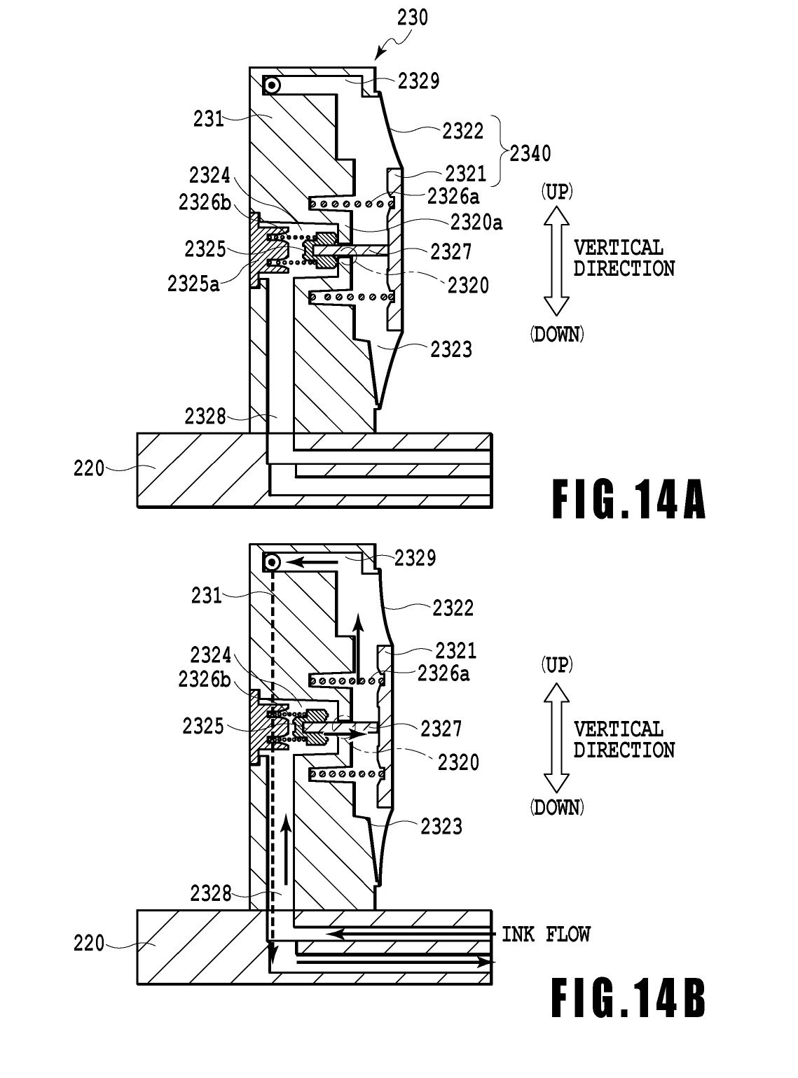

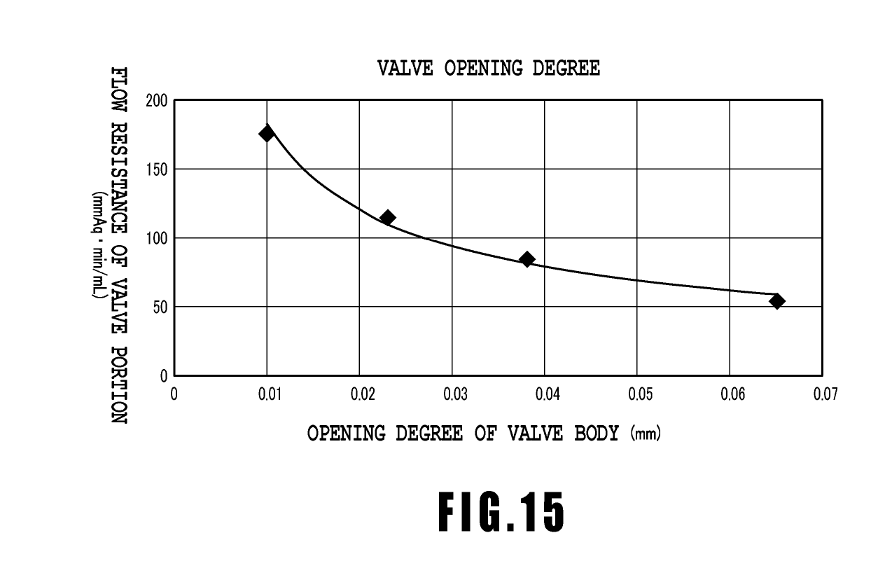

FIGS. 14A and 14B are cross-sectional views taken along a line XIV-XIV of FIG. 13 and FIG. 15 is a cross-sectional view taken along a line XV-XV of FIG. 13. Further, FIG. 14A illustrates a state where a valve body 2325 of the pressure adjustment mechanism provided in the negative pressure control unit 230 is closed so that the pressure control is not performed and FIG. 14B illustrates a state where the valve body 2325 of the pressure adjustment mechanism is opened so that the pressure control is performed.

As illustrated in FIG. 13, an outer shell of the negative pressure control unit 230 is formed by the negative pressure control unit casing 231 and the negative pressure control unit 230 constitutes two pressure adjustment mechanisms L and H along with the negative pressure control unit casing 231. Since the pressure adjustment mechanisms L and H are similar to each other except that one of the pressure adjustment mechanisms is provided at one side of the negative pressure control unit casing 231 and the other thereof is provided at the other side of the negative pressure control unit casing 231, one pressure adjustment mechanism L will be representatively described.

The pressure adjustment mechanism L mainly includes a lid portion 2340 which is provided in the negative pressure control unit casing 231, a valve body 2325, a spring 2326a which urges the lid portion 2340, and a spring 2326a which urges the valve body 2325. The negative pressure control unit casing 231 is provided with an upstream passage 2328 and a downstream passage 2329 of the negative pressure control unit 230. The lid portion 2340 includes a flexible film 2322 which is fixed to the negative pressure control unit casing 231 to keep air tightness and liquid tightness and a pressure receiving plate 2321 which is fixed to the inner face of the flexible film 2322. A pressure control chamber 2323 which liquid-communicates with the downstream passage 2329 is formed between the lid portion 2340 and the negative pressure control unit casing 231. Further, the spring 2326a is interposed between the lid portion 2340 and the negative pressure control unit casing 231 and the lid portion 2340 is urged by the spring 2326 in a direction moving away from a main body, that is, a (outward) direction enlarging the pressure control chamber 2323.

A liquid communication chamber 2324 which fluid-communicates with the upstream passage 2328 is formed inside the negative pressure control unit casing 231 and the valve body 2325 is accommodated into the liquid communication chamber 2324. The valve body 2325 is disposed at a position facing an orifice formed in the liquid communication chamber 2324. A spring seat 2325a is fixed to the negative pressure control unit casing 231 and the valve body 2325 is urged by a spring 2326b provided between the spring seat 2325a and the valve body 2325 in a direction in which an orifice 2320 is closed. The valve body 2325 and the pressure receiving plate 2321 are connected to each other by a shaft 2327 movably inserted into the orifice 2320. The shaft 2327 is fixed to the valve body 2325 and the pressure receiving plate 2321 by adhesive or press-inserting and move along with the valve body 2325 and the pressure receiving plate 2321. The valve body 2325 is provided at the upstream side of the orifice 2320. In a state where the valve body 2325 contacts a partition wall portion 2320a (the valve body 2325 is closed) as illustrated in FIG. 14A, the communication between the orifice 2320 and the liquid communication chamber 2324 is interrupted. Accordingly, the communication between the liquid communication chamber 2324 and the pressure control chamber 2323 is also interrupted. Further, as illustrated in FIG. 14B, the valve body 2325 moves away from the partition wall portion 2320a forming the orifice 2320 (leftward in FIG. 14A) so that a gap is formed between the partition wall portion 2320a and the valve body 2325. The orifice 2320 and the liquid communication chamber 2324 communicate with each other through the gap. As a result, the upstream passage 2328 and the pressure control chamber 2323 communicate with each other. Hereinafter, a portion which is formed by the valve body 2325 and the partition wall portion 2320a facing the valve body 2325 will be referred to as a valve portion. Further, the valve body 2325 may be opened while a gap is formed between the valve body 2325 and the partition wall portion 2320a or the valve body 2325 may be closed while the valve body 2325 and the partition wall portion 2320a contact each other. When the valve body 2325 is opened, the ink which flows from the upstream passage 2328 of the negative pressure control unit 230 flows into the pressure control chamber 2323 through the gap between the valve body 2325 and the orifice 2320 and the pressure is transmitted to the pressure receiving plate 2321. Subsequently, the ink is discharged to the downstream passage 2329.

The pressure inside the pressure control chamber 2323 is determined by the following Formula representing the balance of the forces applied to the components. When the spring forces of the springs 2326a and 2326b serving as the urging members urging the valve body 2325 are changed, a pressure P1 inside the liquid communication chamber 2324 communicating with the upstream passage 2328 can be set to a desired pressure. Additionally, in FIGS. 14A and 14B, two springs 2326a and 2326b serving as urging members are provided in series. However, when the pressure of the pressure control chamber 2323 can satisfy a desired negative pressure value, the urging member of the valve body 2325 may be configured only by one of the springs. Even in this case, a pressure adjustment function is not disturbed.

P2=(P0·S_{d}−(P1·Sᵥ+kx))/(S_{d}−Sᵥ) (Formula 1)

In (Formula 1), S_{d} indicates an area of a pressure receiving portion of the pressure receiving plate, Sᵥ indicates a pressure receiving area of the valve body, P₀ indicates an atmospheric pressure, P1 indicates an upstream pressure of the orifice, P2 indicates a pressure inside the pressure chamber, k indicates a spring constant, and x indicates a spring displacement. Additionally, the spring constant k indicates a synthetic spring constant of two springs 2326a and 2326b.

Further, when a passage resistance of the valve portion is indicated by R and a flow amount of the liquid passing through the orifice 2320 is indicated by Q, the following Formula is established.

P2=P1−QR (Formula 2)

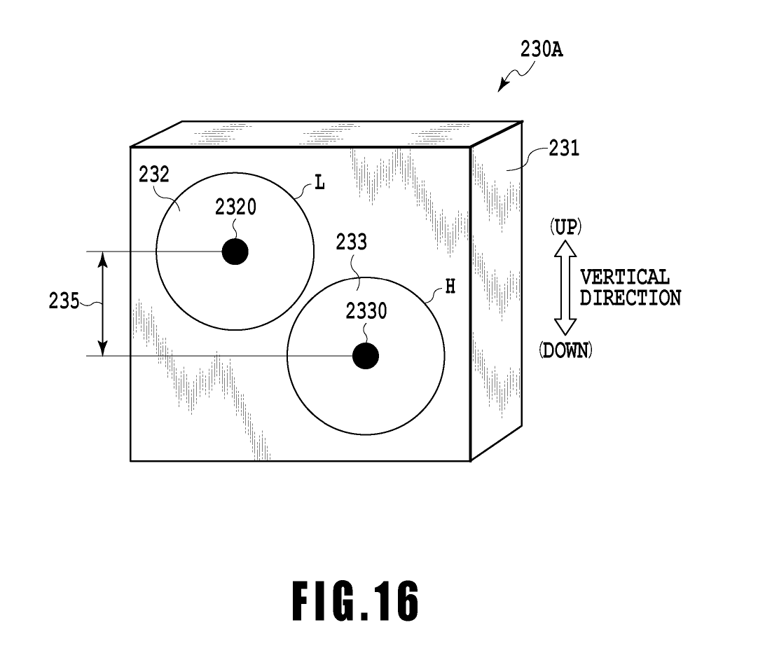

Here, the valve portion is designed so that the passage resistance R and the opening degree of the valve body 2325 have, for example, a relation illustrated in FIG. 16. That is, the passage resistance R decreases in accordance with an increase in opening degree of the valve body 2325. When the position of the valve body 2325 is determined so that (Formula 1) and (Formula 2) are established at the same time, the pressure P2 of the pressure control chamber 2323 is determined.

A pressure of a pressure source (a second circulation pump 1004) connected to the upstream side of the pressure adjustment mechanism L is uniform. For this reason, in a case where the flow amount Q of the liquid flowing into the upstream passage 2328 of the pressure adjustment mechanism L increases, the pressure P1 of the pressure control chamber 2323 decreases by an increased passage resistance amount of the passage from the pressure adjustment mechanism L to a buffer tank 1003 in accordance with an increase in flow amount Q. As a result, the pressure P1·Sv serving as a force of opening the valve body 2325 decreases and thus the pressure P2 of the pressure control chamber 2323 instantly increases by (Formula 1).

Further, a relation of R=(P1−P2)/Q is derived from (Formula 2).

Here, since an increase in pressure P2 inside the pressure control chamber increase, and the upstream pressure P1 of the orifice 2320 decreases flow amount Q, the passage resistance R decreases. As illustrated in FIG. 15, a decrease in passage resistance R indicates an increase in opening degree of the valve body 2325. As illustrated in FIG. 14B, when the opening degree of the valve body 2325 increases, the lengths of the springs 2326a and 2326b decrease. Thus, a displacement x increases from a natural length and thus action forces kx of the springs 2326a and 2326b increase. For this reason, the pressure P2 inside the pressure control chamber 2323 instantly decreases as obvious from (Formula 1). Further, when the pressure P2 inside the pressure control chamber 2323 instantly increases, the pressure P2 inside the pressure control chamber 2323 instantly decreases by an action opposite to the above-described action. In this way, when a change in pressure is instantly repeated so that (Formula 1) and (Formula 2) are satisfied at the same time while the opening degree of the valve body 2325 changes in response to the flow amount Q, the pressure P2 inside the pressure control chamber 2323 is uniformly controlled. Further, as illustrated in FIG. 14A, when the downstream passage 2329 is connected to the upside of the pressure control chamber 2323 in the vertical direction, it is possible to suppress bubbles from staying inside the pressure control chamber 2323. For this reason, the operation of the pressure receiving plate 2321 is not disturbed by bubbles and thus the control pressure value can be stabilized.

While one pressure adjustment mechanism L provided at the pressure control unit 230 has been described, the other pressure adjustment mechanism H also has the same configuration and thus can perform the same pressure control. Here, as will be described below, in the embodiment, two pressure adjustment mechanisms L and H are configured to generate two different negative pressures. Further, as illustrated in FIGS. 13 and 15, two pressure adjustment mechanisms L and H are formed such that components are integrally assembled to the same negative pressure control unit casing 231. In this way, when two pressure adjustment mechanisms L and H are configured as a single unit, a space can be saved.

### Examples

FIG. 16 to FIGS. 22A and 22B are diagrams illustrating examples (first to eighth examples) of generating two different negative pressures in two pressure adjustment mechanisms L and H of the negative pressure control unit 230 used in the embodiment. Further, in FIG. 16 to FIGS. 22A and 22B, the same reference numerals will be given to the same components as those of FIG. 13 and FIGS. 14A and 14B and a detailed description thereof will be omitted. FIG. 16 is a diagram illustrating a negative pressure control unit 230A of the first example. The pressure control unit 230A has a configuration in which the orifice 2320 of one pressure adjustment mechanism L and the orifice 2330 of the other pressure adjustment mechanism H are disposed at different positions (heights) in the vertical direction. Reference Numeral 235 of FIG. 16 indicates a difference in height (a water head difference) between the orifice 2320 and the orifice 2330 in the vertical direction. Accordingly, the water head difference for the ejection opening when the printing head is driven can be set to be different in the orifice 2320 and the orifice 2330 and thus an accurate differential pressure can be generated in the liquids respectively flowing out of the pressure adjustment mechanisms L and H by a water head difference 235. Thus, when the liquids are respectively supplied from the pressure adjustment mechanisms L and H to an individual supply passage 213 and an individual collection passage 214 of the liquid ejection unit 300, a stable differential pressure can be generated between both passages. For this reason, it is possible to reliably realize the flow of the liquid from the common supply passage 211 to the common collection passage 212 inside the liquid ejection unit 300. Further, since all components used in two pressure adjustment mechanisms L and H can be shared, a manufacturing cost can be decreased.

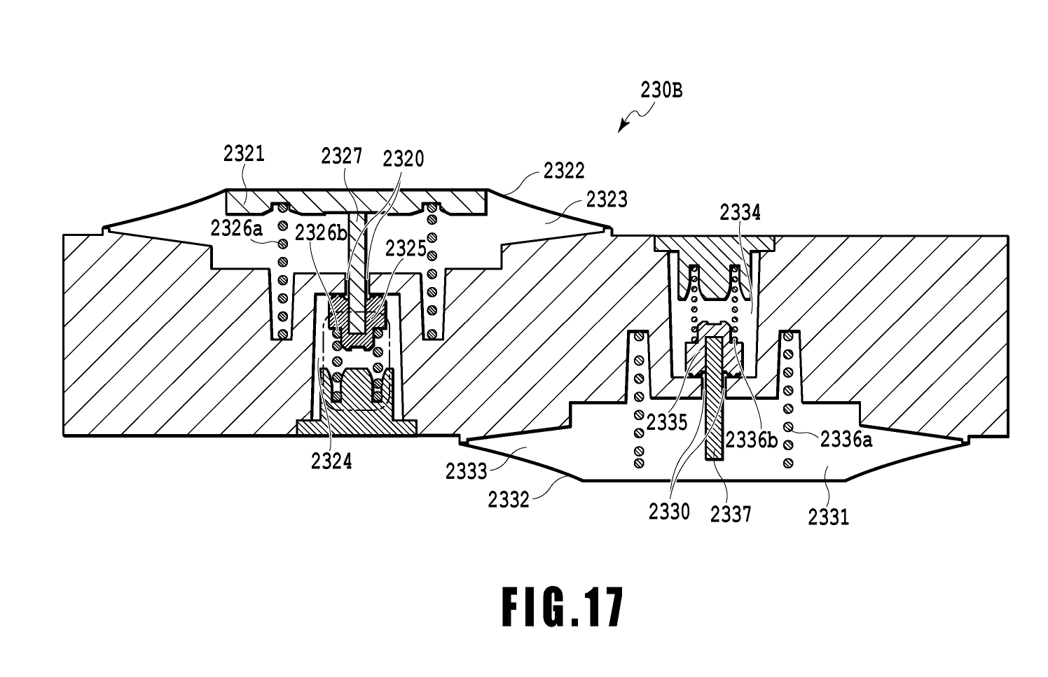

FIG. 17 is a cross-sectional view illustrating a negative pressure control unit 230B of the second example. The negative pressure control unit 230B has a configuration in which the spring constants of the springs provided at two pressure adjustment mechanisms L and H are set to different values. That is, the spring constants are set so that an urging force applied to the valve body 2325 and generated by the springs 2326a and 2326b urging the valve bodies 2325 and 2335 is different from an urging force applied to the valve body 2335 and generated by the springs 2336a and 2336b. In the example illustrated in FIG. 17, among two springs 2326a and 2326b constituting one urging member, only one spring 2326b is set to be different from the spring 2336b of the other urging member and the spring 2326a of one urging member is set to be the same as the spring 2336a of the other urging member. In this way, when only one spring of one urging member is set to be different, all components other than components to be provided as different components among the components used in the negative pressure control mechanism can be shared in two pressure adjustment mechanisms. Accordingly, the number of components can be decreased or the manufacturing cost can be decreased. Here, two springs constituting one urging member may be set to be different from two corresponding springs of the other urging member.

Hereinafter, a detailed example will be described. When a spring constant in which the pressure inside the pressure control chamber 2323 with respect to the atmospheric pressure is set to −100 mmAq in (Formula 1) is indicated by K₁, a following Formula is established.

(P₀S_{d}−(P₁Sv₊k₁x))/(S_{d}−Sᵥ)=P₀−100[mmAq] (Formula 3)

From (Formula 3), K1 is expressed by (Formula 4).

K₁=((P₀−P₁)·Sᵥ+100(S_{d}−Sᵥ))/x (Formula 4)

Here, when a spring constant is indicated by K₂ in a case where only the spring constant is changed so that the pressure inside the pressure control chamber 2323 with respect to the atmospheric pressure is set to −200 mmAq, K₂ is expressed by (Formula 5) similarly to (Formula 4).

K₂=((P₀−P₁)·Sᵥ+200(S_{d}−Sᵥ))/x (Formula 5)

As described above, the pressure control value can be changed in accordance with a change in spring constant K.

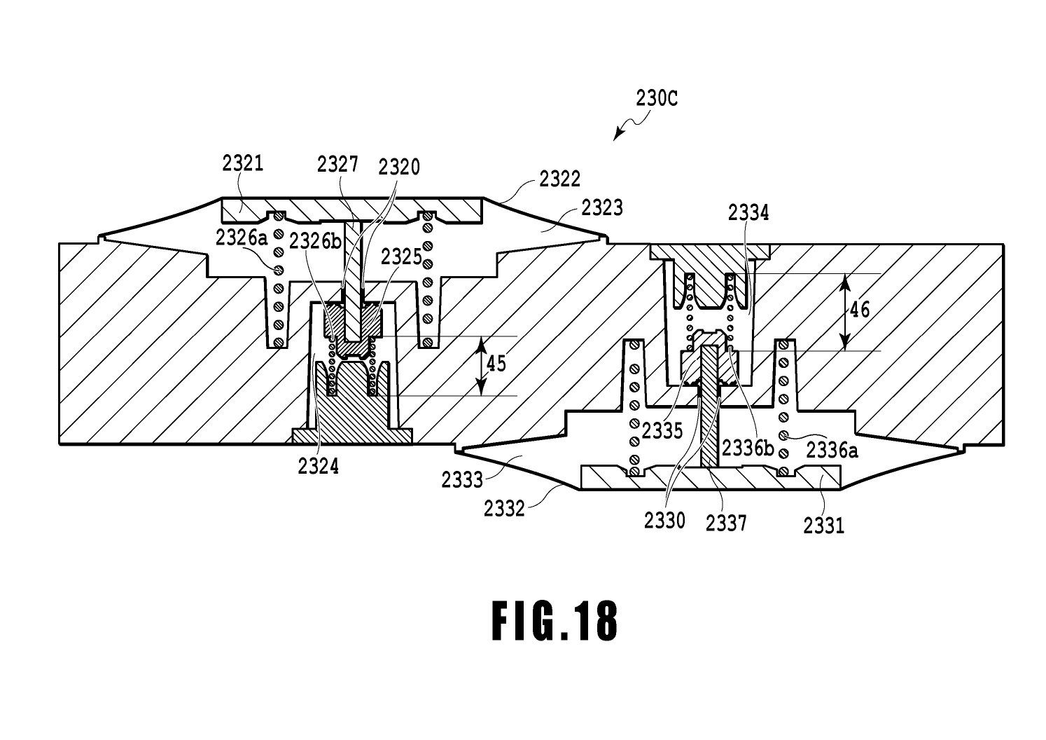

Next, different examples (the third to sixth examples) of generating two different pressures at two pressure adjustment mechanisms L and H of the negative pressure control unit 230 used in the invention will be described with reference to FIG. 18 to FIGS. 21A and 21B.

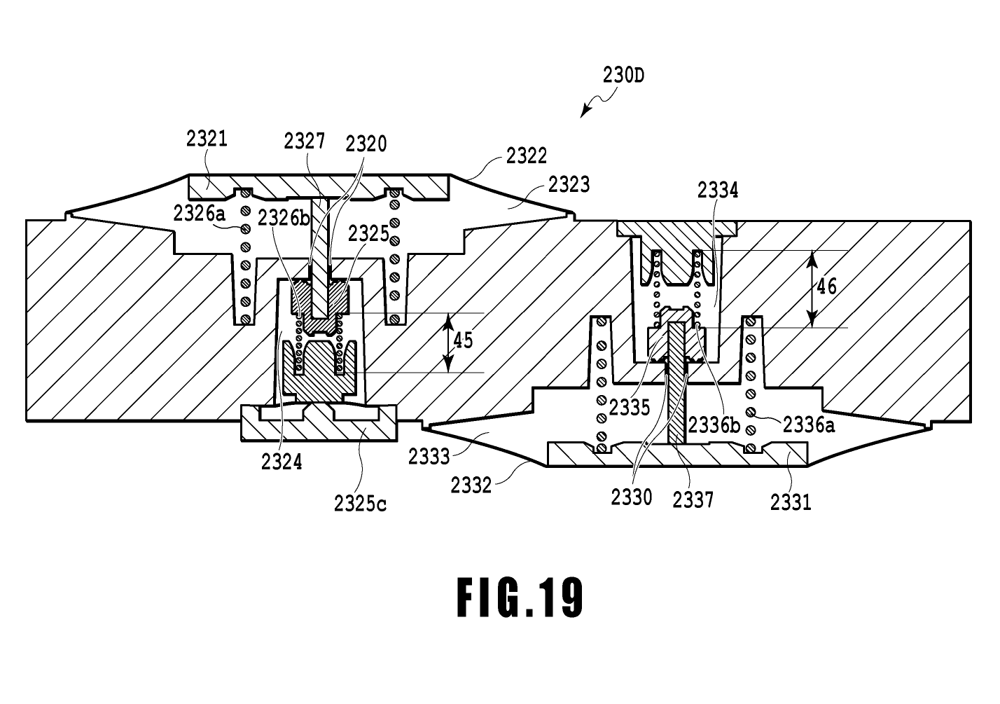

FIG. 18 is a cross-sectional view illustrating the third example and FIG. 19 is a cross-sectional view illustrating the fourth example. Both the third example and the fourth example have a configuration in which springs having the same spring constant are used in two pressure adjustment mechanisms L and H provided in the negative pressure control unit and the lengths of the springs in a state where the valve bodies of the pressure adjustment mechanisms are closed are set to be different from each other.

In the third example and the fourth example, a length 45 of the spring 2326b in a state where the valve body 2325 of the pressure adjustment mechanism L is closed is set to be shorter than a length 46 of the spring 2336b in a state where the valve body 2335 of the other pressure adjustment mechanism L is closed.

In the third embodiment, as illustrated in FIG. 18, a depth (a spring accommodation length) in which the spring seat 2325b accommodates one end of the spring 2325 is set to be deeper (longer) than a depth (a spring accommodation length) in which the spring seat 2335a accommodates the spring 2335. Accordingly, a spring compression amount of one pressure adjustment mechanism in a state where the valve body is closed can be larger than a spring compression amount of the other pressure adjustment mechanism. Further, the pressure generated in one pressure adjustment mechanism L in a state where the valve body is closed can be set to be lower than the pressure generated in the other pressure adjustment mechanism H.

Further, the fourth example includes a spring length adjustment member 2325c which adjusts a position of the spring seat 2325b in a direction in which the spring is lengthened and shortened. In FIG. 19, a position of the spring seat 2325b of one pressure adjustment mechanism L is moved near the partition wall portion 2320a by the spring length adjustment member 2325c. For this reason, a length of the spring in a state where the valve body 2325 is closed is adjusted to be shorter than a length of the spring in a state where the valve body 2335 of the other pressure adjustment mechanism H is closed. Accordingly, a negative pressure generated in one pressure adjustment mechanism L can be set to be lower than a negative pressure generated in the other pressure adjustment mechanism H. Further, in the fourth embodiment, since the position of the spring seat 2325b can be adjusted by the spring length adjustment member, a pressure control value can be adjusted after the negative pressure control unit 230 is assembled. For this reason, a pressure control can be further accurately performed by the spring length adjustment member 2325c and a desired differential pressure can be generated between two pressure adjustment mechanisms L and H. As a result, an ink circulation flow rate at the ejection opening can be adjusted with high accuracy.

Additionally, in the third example and the fourth example, one spring (in FIGS. 18 and 19, the spring 2326b contacting the valve body 2325) of two springs provided in series in the pressure adjustment mechanism L is adjusted. However, a length (a compression amount) of the spring 2326a contacting the pressure receiving plate 2321 among the springs provided in series may be adjusted. Further, both lengths of two springs 2326b and 2326b may be adjusted. At least one spring (2336b or 2336a) of two springs at the other pressure adjustment mechanism H may be adjusted. In this case, the length of at least one spring 2336a or 2336b in the pressure adjustment mechanism H may be adjusted to be longer than the lengths of the springs 2326a and 2326b of the pressure adjustment mechanism L (so that a compression amount becomes small).

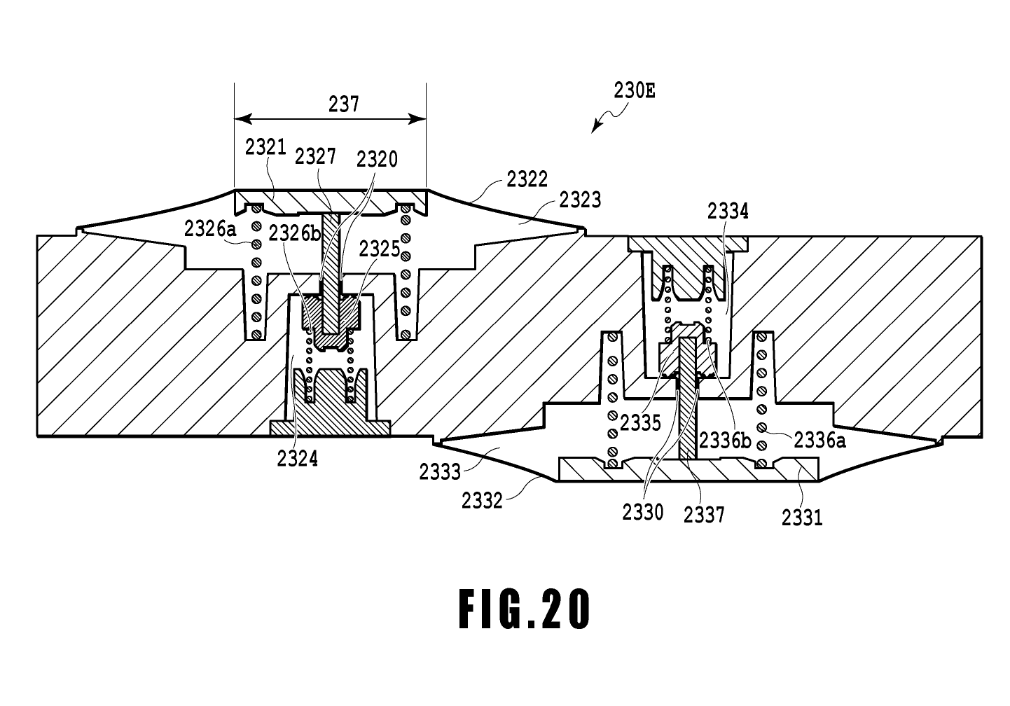

FIG. 20 is a cross-sectional view illustrating a fifth example. The fifth example has a configuration in which the pressure receiving plates 2321 and 2333 serving as the pressure receiving portions respectively have different pressure receiving areas receiving pressures from the pressure control chambers 2323 and 2333. That is, when an area of the pressure receiving plate 2331 at the pressure adjustment mechanism H is set to be larger than an area of the pressure receiving plate 2333 at the pressure adjustment mechanism L, a difference in pressure can be generated between the pressure of the pressure control chamber 2323 at the pressure adjustment mechanism L and the pressure of the pressure control chamber 2333 at the pressure adjustment mechanism H. Further, when the areas of the pressure receiving plates 2321 and 2332 are set to be large, it is possible to reduce an influence of a change in pressure of the pressure P1 applied from the upstream side. Thus, when the areas of the pressure receiving plate 2321 and the pressure receiving plate 2332 are set to be different from each other and both areas of the pressure receiving plates 2321 and 2332 are set to be large, it is possible to effectively generate an accurate difference in pressure between the pressure of the pressure control chamber 2323 and the pressure of the pressure control chamber 2333 at the pressure adjustment mechanisms L and H.

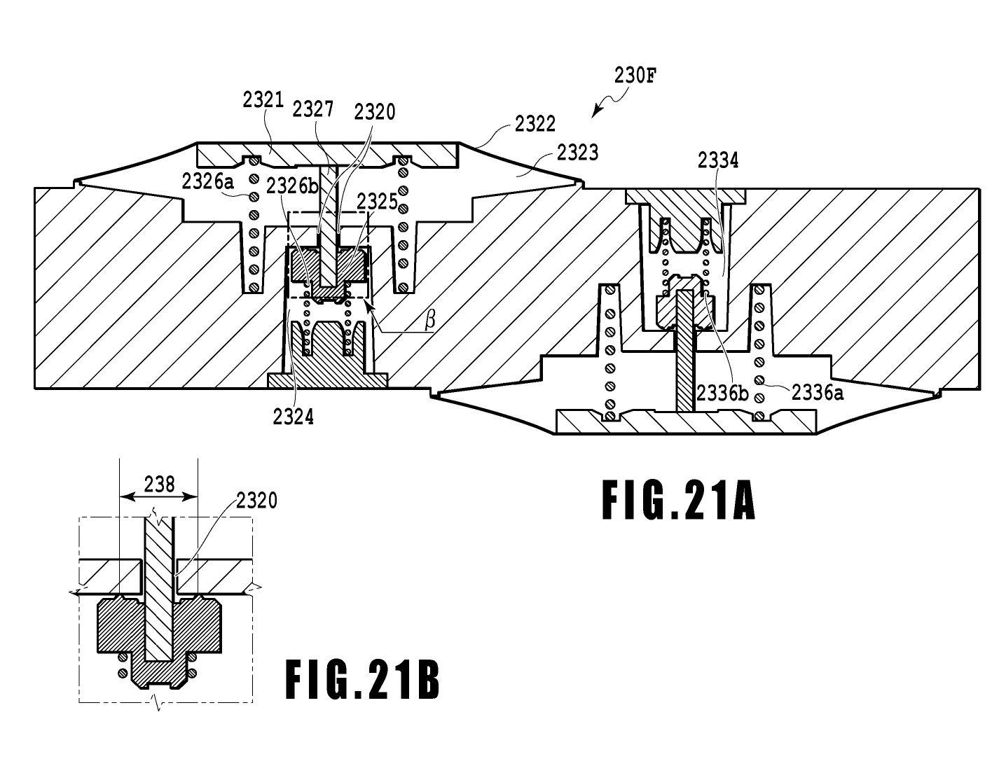

FIG. 21A is a cross-sectional view illustrating the sixth example, and FIG. 21B is an enlarged perspective view illustrating a part β indicated by in FIG. 21A. The sixth example has a configuration in which the pressure receiving areas of the valve bodies 2325 and 2335 of the pressure adjustment mechanisms L and H are set to be different from each other. The pressure receiving areas of the valve bodies 2325 and 2335 indicate inner regions (below) surrounded by positions contacting partition wall portions 2320a and 2330a when the valve bodies close the orifices 2320 and 2330. Hereinafter, this region will be referred to as a pressure receiving region. The pressures in the liquid flow chambers 2324 and 2334 are applied to the pressure receiving regions of the valve bodies 2325 and 2335 so that a force of moving the valve bodies 2325 and 2335 is generated by a differential pressure between the applied pressures and the pressures inside the pressure control chambers 2323 and 2333. Here, the pressure receiving regions of the valve bodies 2325 and 2335 change in response to the shapes of the valve bodies 2325 and 2335. For this reason, in a case where the pressure receiving regions are different from the shapes of FIGS. 21A and 21B, the pressures applied to the valve bodies 2325 and 2335 change so that a force of moving the valve bodies 2325 and 2335 may change.

When the pressure receiving areas of the valve bodies 2325 and 2335 decrease, the pressure receiving plates 2321 and 2331 can be decreased in size and thus the pressure control unit 230 can be decreased in size. However, when the pressure receiving areas of the valve bodies 2325 and 2335 decrease, the valve bodies 2325 and 2335 are easily inclined and the passage resistance in the valve portion easily changes. For this reason, there is a possibility that the pressure control becomes unstable.

As described above, in a case where any one of the spring, the pressure receiving plate, and the valve body of one pressure adjustment mechanism and the other pressure adjustment mechanism is set to be different, the different components cannot be shared and thus the number of components increases. Particularly, since the pressure receiving plate or the valve body is generally manufactured by molding, there is concern that a manufacturing cost may increase due to an increase in number of molding components. However, since the spring is manufactured without molding, a molding die is not necessary and thus an increase in cost caused by an increase in type of spring in use can be suppressed. For this reason, it is desirable that the spring constants of the springs urging the valve bodies are different from each other as a method of generating a difference in pressure in each of the pressure control chambers of two pressure adjustment mechanisms.

Additionally, in the above-described examples, the flexible film is used as one of components of the pressure control chamber, but the invention is not limited to the flexible sheet. For example, the other members can be used as long as a fluid-sealing function can be exhibited and the movement of the pressure receiving plate or the opening/closing operation of the valve body is not disturbed.

Further, the first to sixth examples can be performed solely or together. Further, the examples can be appropriately combined with one another and the range of the pressure control can be further enlarged by the combination of the examples.

### (Example of Connection Between Negative Pressure Control Unit and Passage)

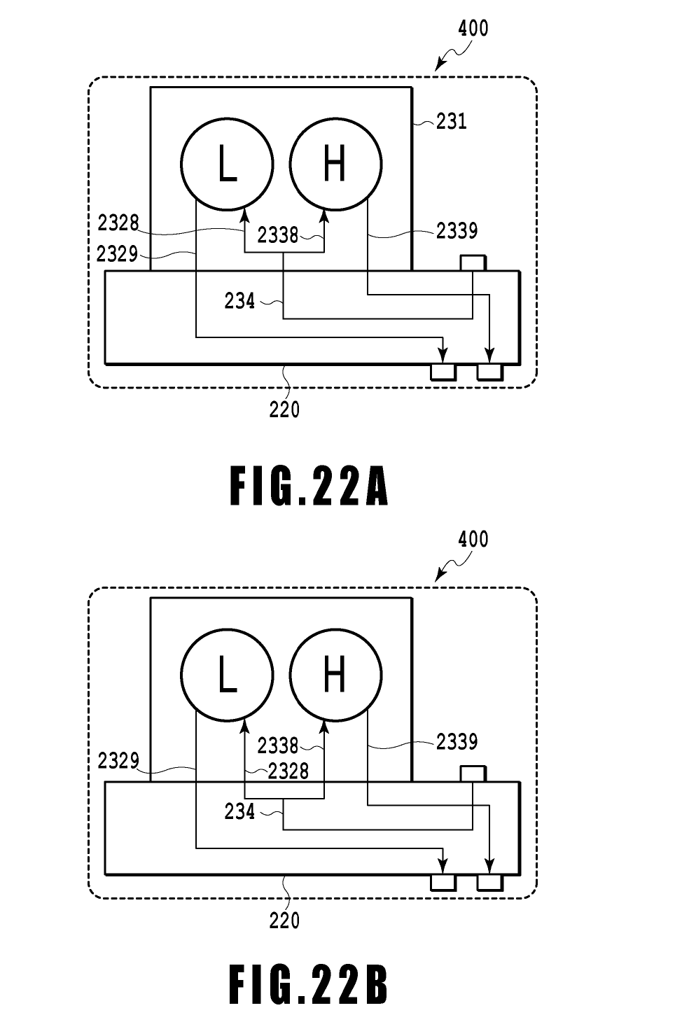

FIGS. 22A and 22B are schematic diagrams illustrating examples (seventh and eighth examples) of a connection between the passage and the negative pressure control unit 230 of the embodiment. In the seventh example, as illustrated in FIG. 22A, the upstream passages 2328 and 2338 of the pressure adjustment mechanisms L and H communicate with each other inside a main body 231. Further, in the eighth example, as illustrated in FIG. 22B, the upstream passages 2328 and 2338 communicate with each other outside the main body 231 and inside the pressure control assembly 400.

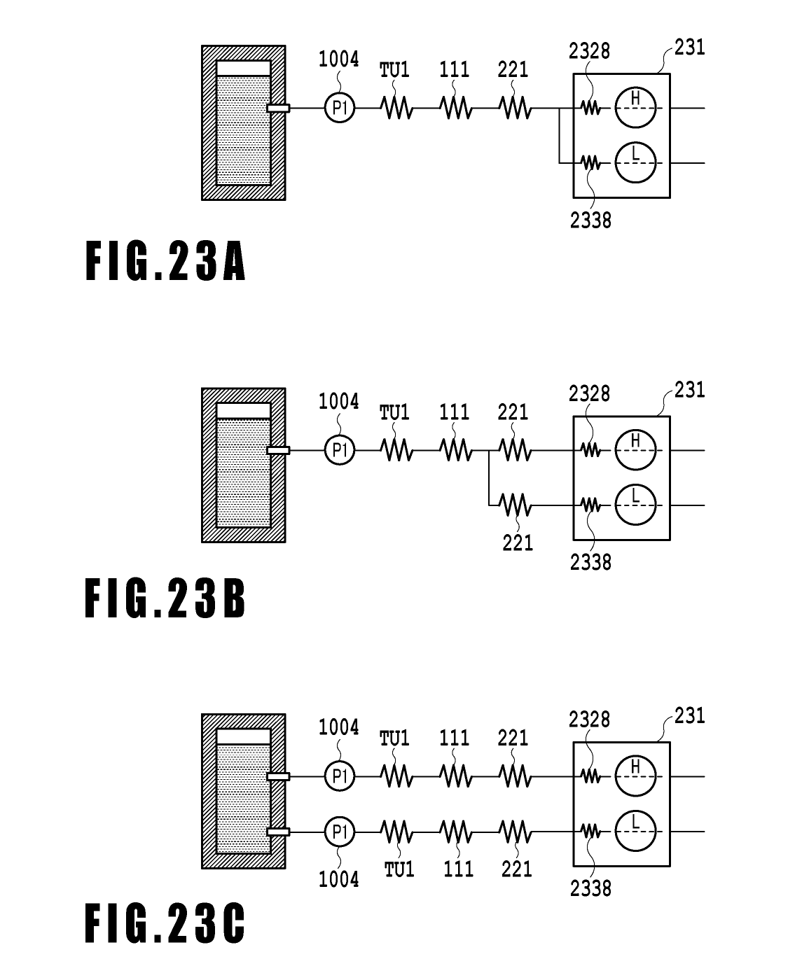

In order to realize a high-quality image printing operation, there is a need to stabilize the flow rate of the ink flowing through the liquid ejection unit 300. Accordingly, there is a need to stabilize a difference (a differential pressure) between the control pressures of two pressure adjustment mechanisms L and H serving as the ink flow generation sources. In order to stabilize the differential pressure, it is effective that the pressure values applied to two pressure adjustment mechanisms L and H be substantially equal to each other. For this reason, in the seventh and eighth examples, two upstream passages 2328 and 2338 respectively communicating with the pressure adjustment mechanisms L and H communicate with each other. Further, it is desirable that the communication position between the upstream passages 2328 and 2338 be set in the vicinity of the pressure adjustment mechanism in order to reduce the pressure loss in the passage extending from the pressure generation source to two pressure adjustment mechanisms L and H. Here, in the seventh and eighth examples, as illustrated in FIGS. 23A and 23B, a communication position between the upstream passages 2328 and 2338 is defined inside the pressure control assembly 2000.

Here, in a case where the upstream passages 2328 and 2338 communicate with each other or do not communicate with each other in the vicinity of the pressure adjustment mechanisms L and H, a tolerance of the pressure loss generated between the pressure generation source and two pressure adjustment mechanisms L and H is compared. Additionally, FIGS. 23A to 23C are schematic fluid circuit diagrams illustrating a connection between the negative pressure control unit 230 and the pressure generation source, FIG. 23A illustrates a fluid circuit of the sixth example of FIG. 22A, and FIG. 23B illustrates a fluid circuit of the seventh example of FIG. 22B. Further, FIG. 23C illustrates a fluid circuit according to a comparative example of the seventh and eighth examples. In the comparative example, the upstream passages of the pressure adjustment mechanisms L and H do not communicate with each other.

The components constituting the fluid circuit illustrated in FIGS. 23A to 23C have the following configuration. First, a pump (P1) 1004 serving as a pressure source disposed outside the liquid ejection head 3 is used as the pressure generation source. As the passage extending from the pump 1004 to the negative pressure control unit 230, a tube TU1 having a length of 3000 mm and an inner diameter of φ2.5±0.1 mm is used. A liquid connection portion 111 connecting the tube TU1 and the liquid ejection head 3 to each other has a length of 10 mm and an inner diameter of φ1±0.1 mm. The filter 221 having a resistance allowance of ±10% of 500 mm̂2 is connected to the liquid connection portion 111. The upstream passages 2328 and 2338 each having a length of 50 mm, a height of 3±0.1 mm, and a width of 5±0.1 mm and disposed inside the negative pressure control unit 230 are connected to the filter 221.

In the passage configuration illustrated in FIGS. 23A to 23C, when the ink having a viscosity of 8 cp flows at a flow rate of 50 ml/min, the passage resistance inside the tube TU1 and the liquid connection portion 111 is expressed by (Formula 6) and the passage resistance inside the negative pressure control unit 230 is expressed by (Formula 7). Further, the resistance coefficient of the filter 221 is set to 300 mmAq/(ml/min)·mm̂2/cp.

R=8·η·L/π·r̂4 (Formula 6)

In (Formula 6), R indicates a passage resistance, η indicates a viscosity, L indicates a length, π indicates a circumference constant, and r indicates a cylindrical passage radius.

R=12*η*L*(0.33+1.02*(a/b+b/a))/(a*b)̂2 (Formula 7)

In (Formula 7), a indicates a passage height and b indicates a passage width.

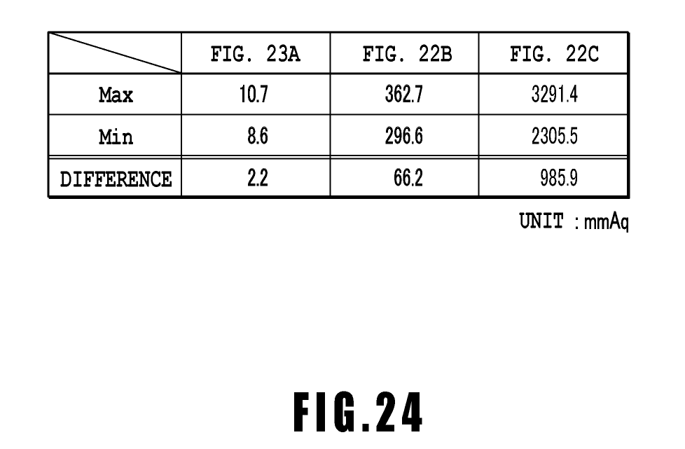

Here, a pressure loss calculation result of each component is illustrated in FIG. 24.

As illustrated in the result of FIG. 24, in the comparative example of FIG. 23C in which the upstream passages 2328 and 2338 do not communicate with each other, the pressures applied to two pressure adjustment mechanisms L and H have a difference of 985.9 mmAq to maximum caused by the common difference of the passage resistance. Further, in a case where the upstream passages 2328 and 2338 communicate with each other in the vicinity of two pressure adjustment mechanisms L and H similarly to the seventh example of FIG. 23A, the pressures applied to two pressure adjustment mechanisms L and H have a difference of 2.2 mmAq to maximum caused by the common difference of the passage resistance. In this way, in the seventh embodiment, a difference in pressure caused by the common difference of the passage resistance is reduced to about 1/450 of a difference in pressure generated in the comparative example.

Further, in a case where the upstream passages 2328 and 2338 fluid-communicate with each other at the upstream side of the filter 221 similarly to the eighth example illustrated in FIG. 23B, a difference of 66.2 mmAq to maximum is generated between the pressures applied to two pressure adjustment mechanisms L and H due to the allowance of the passage resistance. Thus, in the eighth example, a difference in pressure generated by the common difference of the passage resistance is reduced to about 1/30 of a difference in pressure generated in the comparative example.

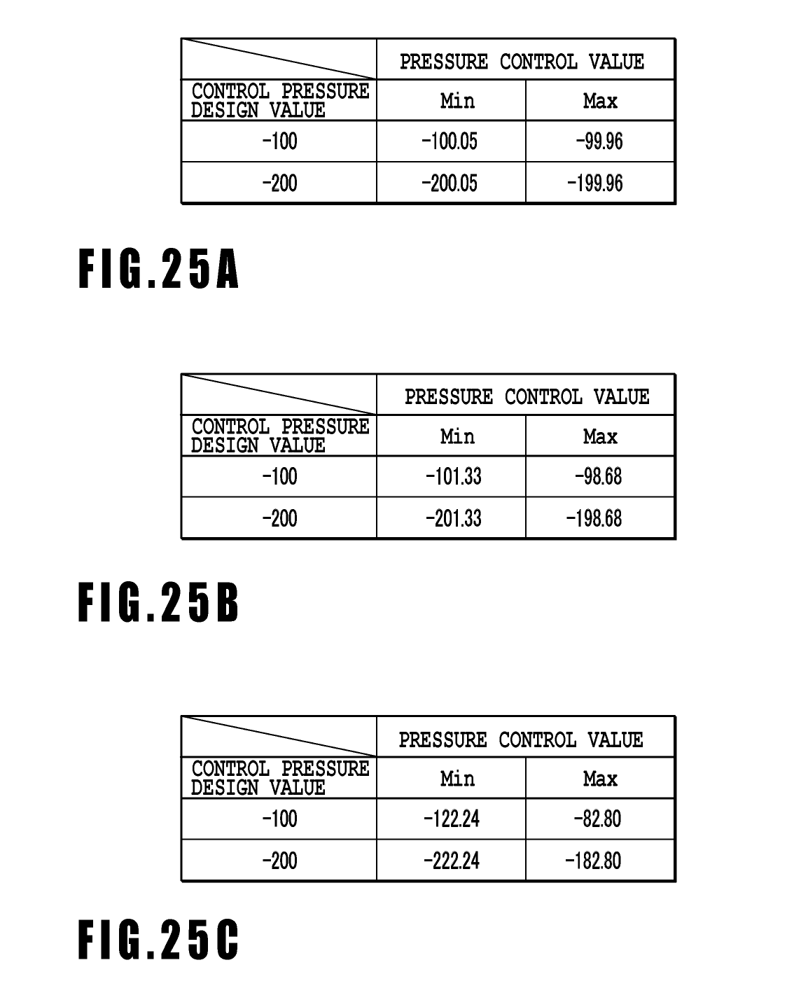

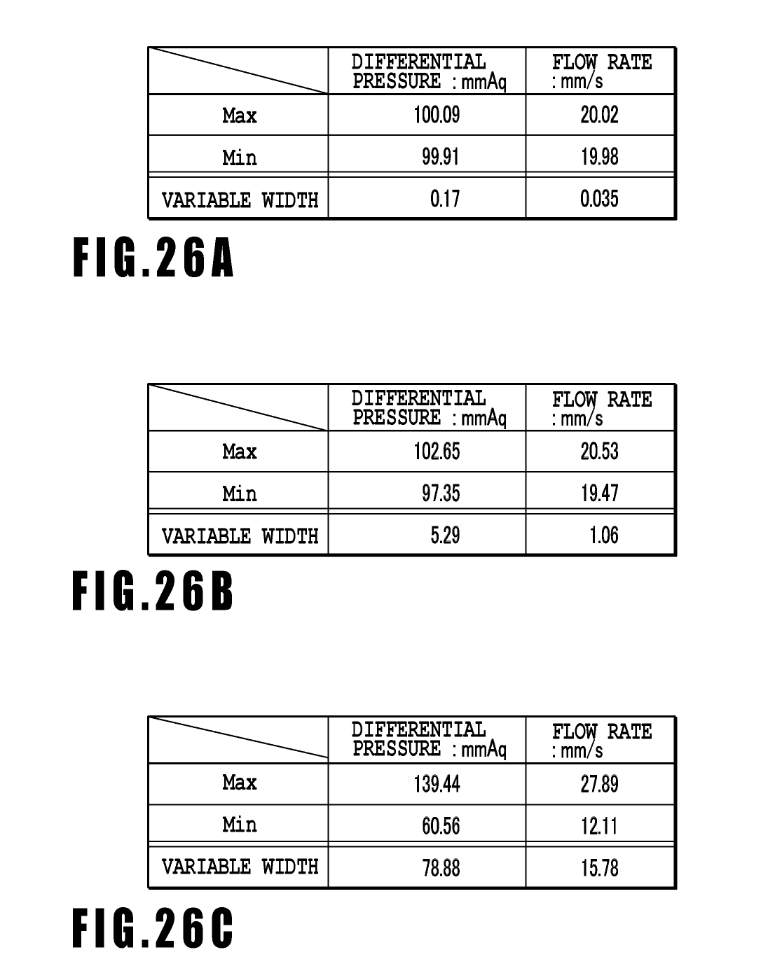

As described above, since a difference between the pressures applied to two pressure adjustment mechanisms L and H is generated by the common difference of the passage resistance, the control pressure values of two pressure adjustment mechanisms L and H change as below. Now, a case will be supposed in which the control pressure design value of the pressure adjustment mechanism H is set to −100 mmAq and the control pressure design value of the pressure adjustment mechanism H is set to −200 mmAq on the basis of (Formula 1). Here, in (Formula 1), Sv is set to 19.2 mm̂2, Sd is set to 500 mm̂2, P1−P0 is set to 2000 mmAq, and k is set to 9.8065×10̂−3 N/mm̂2. In this case, in the fluid circuit (the comparative example) of FIG. 23C, the pressure control values of the pressure adjustment mechanisms L and H are set as illustrated in FIG. 25C. The flow rate of the liquid flowing through the ink circulation passage 13b supplying and discharging the ink to the ejection opening 13 by the difference (the differential pressure) of the pressure control value is illustrated in FIG. 26C.

As illustrated in FIG. 26C, the differential pressure of the pressure control value of the comparative example is set such that a maximal value (Max) is 139.44 mmAq and a minimal value (Min) is 60.56 mmAq. That is, a variable width of the differential pressure becomes 78.88 mmAq. In this way, since the differential pressure changes, the flow rate of the liquid flowing through the ink circulation passage 13b supplying and discharging the ink to the ejection opening 13 changes as below. Now, the differential pressure of the control pressure design value is set to 100 mmAq and the flow rate of the liquid (the design flow rate value) flowing through the ink circulation passage 13b supplying and discharging the ink to the ejection opening 13 by the differential pressure is set to 20 mm/s. At this time, in FIG. 26C, the maximal value of the flow rate becomes 27.89 mm/s and the minimal value thereof becomes 12.11 due to a change in differential pressure. Thus, the variable width ((the maximal value of the flow rate)−(the minimal value of the flow rate)) of the flow rate of the liquid caused by a change in differential pressure becomes 15.78 mm/s. Thus, the flow rate of the liquid has a change of about ±39.4% due to the differential pressure of the control pressure design value in FIG. 26C. In this way, since the flow rate of the ink flowing through the ink circulation passage 13b supplying and discharging the ink to the ejection opening 13 changes largely, the negative pressure of the ejection opening also changes and thus a high-quality image cannot be easily printed.

Meanwhile, in the fluid circuit of the eighth example illustrated in FIG. 23B, in a case where the control pressure design value is set as illustrated in FIG. 25B, the difference between the control pressures of the pressure adjustment mechanisms L and H and the maximal and minimal values of the flow rate of the liquid flowing through the ink circulation passage 13b supplying and discharging the ink to the ejection opening 13 are set as illustrated in FIG. 26B. In the case of FIG. 26B, the minimal value of the flow rate becomes 19.47 mm/s, the maximal value thereof becomes 20.53 mm/s, and a variable width of the flow rate becomes 1.06 mm/s. That is, in the eighth example, the flow rate of the liquid flowing through the ink circulation passage 13b supplying and discharging the ink to the ejection opening 13 changes by about ±2.6% with respect to the design flow rate value of 20 mm/s. The variable width of the flow rate becomes about 1/15 with respect to the variable width of the flow rate of the comparative example of FIG. 25C.

Further, in the fluid circuit of the seventh example illustrated in FIG. 26A, in a case where the control pressure design value is set as illustrated in FIG. 25A, the difference of the pressure control value and the maximal and minimal values of the flow rate of the liquid flowing through the ink circulation passage 13b supplying and discharging the ink to the ejection opening 13 by the differential pressure are set as illustrated in FIG. 26A. In the case of FIG. 26A, the minimal value of the flow rate becomes 19.98 mm/s, the maximal value thereof becomes 20.02 mm/s, and the variable width of the flow rate becomes 0.035. Thus, in the seventh example, the flow rate of the liquid flowing through the ink circulation passage 13b supplying and discharging the ink to the ejection opening 13 changes by about ±0.09% with respect to the design flow rate value and thus the flow rate substantially does not change.

As described above, it is desirable to fluid-connect two upstream passages 2328 and 2338 communicating with two pressure adjustment mechanisms L and H in the vicinity of the pressure adjustment mechanisms in order to stabilize the flow rate of the liquid flowing through the ink circulation passage 13b supplying and discharging the ink to the ejection opening 13.

The communication position between two upstream passages 2328 and 2338 provided in the negative pressure control unit 230 may be set inside the main body 231 as illustrated in FIG. 22A, but may be set outside the negative pressure control unit casing 231 as illustrated in FIG. 22B. In order to reduce the common difference of the passage resistance, it is desirable that the communication position between two upstream passages 2328 and 2338 be set to a position closer to the pressure adjustment mechanisms L and H. From this respect, the passage configuration illustrated in FIG. 22A is desirable. Here, as illustrated in FIG. 22B, in a configuration in which two upstream passages 2328 and 2338 communicate with each other outside the negative pressure control unit casing 231, the passage does not need to be branched inside the negative pressure control unit casing 231. For this reason, the negative pressure control unit casing 231 can be formed in a shape in which an injection-molding operation can be easily performed. Thus, the passage configuration illustrated in FIG. 22B is effective from the viewpoint of reducing the difficulty level when the negative pressure control unit 230 is manufactured. Thus, it is desirable to employ the configuration of FIG. 22B and to fluid-connect two upstream passages 2328 and 2338 in the vicinity of the negative pressure adjustment unit. Further, in FIG. 22B, two upstream passages 2328 and 2338 communicate with each other inside the liquid supply unit 230, but the communication position is not limited to the inside of the liquid supply unit 230 and may be the outside of the pressure control assembly 400. However, in this case, there is a need to suppress a distance from the fluid-connection position to the pressure adjustment mechanism to minimum in order to suppress a change in pressure caused by the common difference of the passage resistance at the upstream side of the pressure adjustment mechanisms L and H.

Further, as illustrated in FIG. 3, the filter 221 is disposed to suppress the ejection opening from being blocked by a trash produced by a manufacturing process or a deposit from the ink. When the filter 221 is disposed at the upstream side in relation to the communication position between two upstream passages 2328 and 2338, the filter 221 serving as a resistor can be shared. This can be realized by the passage configuration illustrated in FIG. 23A. In this way, since the filter 221 is shared, a space can be saved and the differential pressure between the control pressure of the pressure adjustment mechanism L and the control pressure of the pressure adjustment mechanism H can be stabilized as illustrated in FIGS. 24A and 23A. For this reason, since a change in flow rate of the liquid flowing through the liquid ejection unit 300 can be suppressed, a high-quality image printing operation can be realized.

### (Modified Example of Filter Accommodation Chamber)

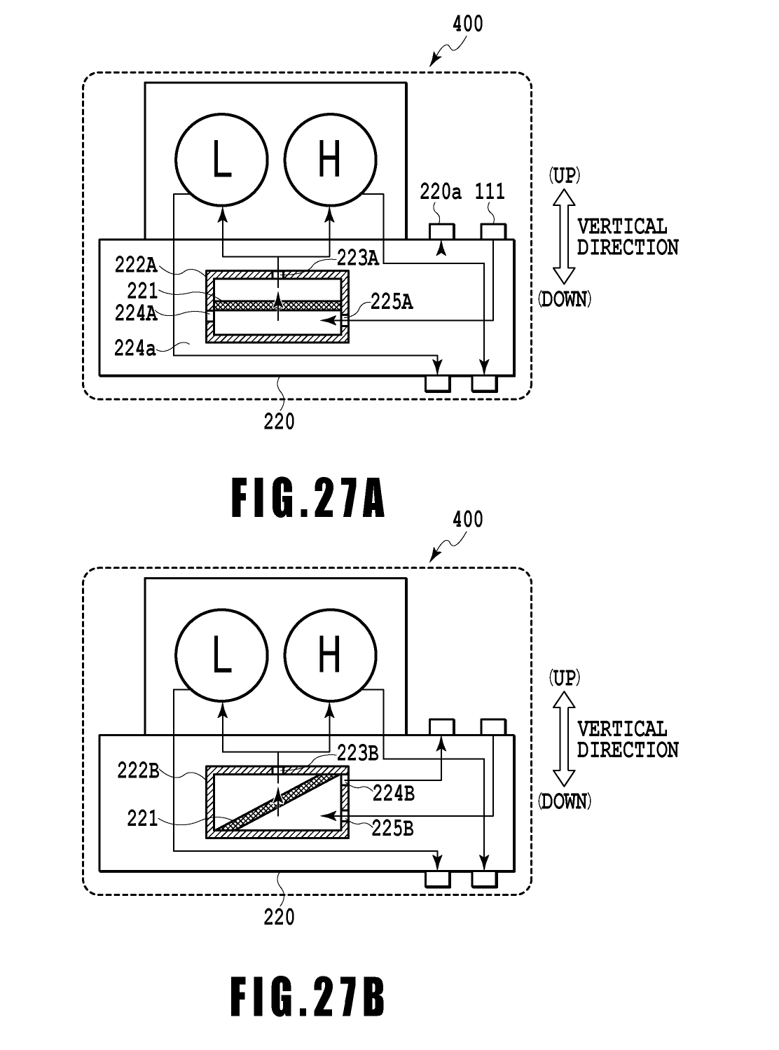

FIGS. 27A and 27B are schematic diagrams illustrating a modified example of the filter accommodation chamber 222 illustrated in FIG. 3, FIG. 27A illustrates a first modified example, and FIG. 27B illustrates a second modified example. A filter accommodation chamber 221A of a first modified example illustrated in FIG. 27A is provided inside the liquid supply unit 220 similarly to the filter accommodation chamber 222 illustrated in FIG. 3. The filter 221 is disposed inside the filter accommodation chamber 222A to divide the inside of the filter accommodation chamber 222 into the upstream and downstream areas. In the first modified example, the filter 221A is disposed along a plane (a horizontal plane) orthogonal to the vertical direction. An inflow opening 225 is formed at the vertical lower portion of the filter accommodation chamber 222A. An inflow opening 225A is connected to the liquid connection portion 111 provided in the liquid supply unit 220. Further, an outflow opening 223 is provided at the vertical upper portion of the filter accommodation chamber 222A. An outflow opening 223A is connected to the upstream passage in relation to the communication portion between the upstream passages 2328 and 2338 of the pressure control mechanisms L and H. Further, the filter accommodation chamber 222A is formed such that an exhaust opening 224A is formed in the vicinity of the lower face of the filter 221. The exhaust opening 224A is connected to an exhaust portion 220a of the liquid supply unit 220 through a bypass passage 224a.

As described above, in the first modified example, the outflow opening 223 is provided at the vertical upper portion of the filter accommodation chamber 222A so that air inside the filter accommodation chamber 222A is easily discharged. For this reason, since bubbles moving upward by a buoyant force can be discharged from the outflow opening 223A, it is possible to suppress bubbles from staying inside the filter accommodation chamber 222A. Further, since the exhaust opening 224A is provided at the lower face of the filter 221A, bubbles rising to the filter 221 can be discharged from the exhaust opening 224A to the outside through the bypass passage 224a. In this way, since it is possible to suppress air from staying inside the filter accommodation chamber 222A, it is possible to suppress a change in effective area of the filter 221A serving as a resistor. For this reason, it is possible to stabilize the passage resistance value of the passage extending from the pump 100 serving as an upstream pressure source to two pressure adjustment mechanisms L and H. Thus, according to the filter accommodation chamber 222A of the first modified example, since the pressure values controlled by two pressure adjustment mechanisms are further stabilized, it is possible to further reduce a change in flow rate of the ink flowing through the liquid ejection unit 300 by a predetermined differential pressure and to realize a high-quality image printing operation.

Further, in the second modified example illustrated in FIG. 27B, a filter 221B is disposed inside a filter accommodation chamber 222B to have a predetermined inclination angle with respect to the horizontal direction and the filter accommodation chamber 222B is divided into two upstream and downstream areas by the filter 221B. Even in the second modified example, the outflow opening 223 is provided at the vertical upper portion of the filter accommodation chamber 222B and an inflow opening 223B is disposed at the vertical lower portion of the filter accommodation chamber 222B. Further, the filter accommodation chamber 222B is formed so that an exhaust opening 224B communicating with the upstream area is formed at the vertical upper side of the inflow opening 223 and is connected to the exhaust portion 220a of the liquid supply unit 220.

In the second modified example, air can be discharged from the outflow opening 224B provided at the vertical upper portion and bubbles rising to the filter 221B can be discharged from the exhaust opening 224 similarly to the first modified example. Further, in the second modified example, since the filter 221B is disposed to be inclined, bubbles mixed with the ink flowing to the upstream area can be raised along the inclined face of the filter 222B and be discharged from the exhaust opening 224B. For this reason, an effect of suppressing bubbles from staying inside the filter accommodation chamber 222B is further improved and thus a change in effective area of the filter 221 can be further effectively suppressed.

Further, in the embodiments and the first and second modified examples, an example has been described in which the filter accommodation chambers 222A and 222B are disposed inside the liquid supply unit 220, but the arrangement positions of the filter accommodation chambers 222A and 222B may be set to the inside of the negative pressure control unit 230 or the outside of the pressure control assembly 400. In this case, the filter accommodation chambers may be disposed at the upper positions, the lower positions, or the same position of the pressure adjustment mechanisms L and H in the vertical direction, but an arrangement capable of shortening a distance between the pressure adjustment mechanisms L and H and the pressure control mechanism 233 is desirable. For example, as illustrated in FIGS. 27A and 27B, in a case where the connection portion between the upstream passages 2328 and 2338 of the pressure adjustment mechanisms L and H is formed at the vertical lower portion of the negative pressure control unit, it is desirable to dispose the filter accommodation chamber 222 at the vertical lower portions of the pressure adjustment mechanisms L and H. That is, since the filter accommodation portion is disposed at the vertical lower portions of the pressure adjustment mechanisms L and H, it is possible to shorten a distance from the filter 221 to the pressure adjustment mechanisms L and H. For this reason, it is possible to reduce the pressure loss generated from the pump 1004 serving as a pressure source to the pressure adjustment mechanism 233 and thus to perform a highly accurate pressure control.

### Other Embodiments

Further, the above-described embodiment does not limit the scope of the invention. As an example, in the embodiment, a thermal type of ejecting a liquid by generating bubbles using a heating element has been described, but the invention can be also applied to a liquid ejection head of a piezo type or the other liquid ejection types.

As the embodiment of the invention, an inkjet printing apparatus (a printing apparatus) in which a liquid such as ink is circulated between a tank and a liquid ejection head has been described, but the other embodiments may be employed. For example, instead of the circulation of the ink, a configuration may be employed in which two tanks are provided at the upstream and downstream sides of the liquid ejection head and the ink flows from one tank to the other tank so that the ink inside the pressure chamber of the liquid ejection head flows.

Further, in the embodiment, an example of a so-called line type head having a length corresponding to a width of a print medium has been described, but the invention can be also applied to a so-called serial type liquid ejection head that prints an image on a print medium while scanning the print medium. As the serial type liquid ejection head, for example, a configuration equipped with a print element board ejecting black ink and a print element board ejecting color ink can be exemplified, but the invention is not limited thereto. That is, a short liquid ejection head which is shorter than a width of a print medium and in which a plurality of print element boards are disposed so that ejection openings overlap each other in an ejection opening array direction is provided and the print medium is scanned by the liquid ejection head.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-003086, filed Jan. 8, 2016, which is hereby incorporated by reference wherein in its entirety.

What is claimed is:

1. A liquid ejection printing apparatus that performs printing by ejecting a liquid from an ejection opening formed in a liquid ejection head, the liquid ejection printing apparatus comprising:
a pressure control assembly that generates a pressure for causing a liquid to flow to an ejection opening communication passage communicating with the ejection opening,
wherein the pressure control assembly includes:
a first upstream passage,
a first pressure adjustment mechanism that causes a liquid supplied from a first upstream passage to flow therefrom at a first pressure, and
a second upstream passage,
a second pressure adjustment mechanism that causes a liquid supplied from a second upstream passage to flow therefrom at a second pressure different from the first pressure, a first downstream passage that supplies a liquid to the ejection opening communication passage from the first pressure adjustment mechanism,
a second downstream passage that supplies a liquid to the ejection opening communication passage from the second pressure adjustment mechanism,
wherein the first upstream passage and the second upstream passage communicate with each other, and
wherein the first downstream passage and the second downstream passage are respectively connected to the same ejection opening communication passage.

2. The liquid ejection printing apparatus according to claim 1,
wherein the first upstream passage and the second upstream passage communicate with each other within the pressure control assembly.

3. The liquid ejection printing apparatus according to claim 1,
wherein a pressure source supplying a liquid at a predetermined pressure is connected to the first and second upstream passages and a filter that removes foreign substance contained in a liquid is provided between the pressure source and the first and second upstream passages, and
wherein the first upstream passage and the second upstream passage communicate with each other between the filter and the first and second pressure control mechanisms.

4. The liquid ejection printing apparatus according to claim 1,
wherein a pressure source supplying a liquid at a predetermined pressure is connected to the first and second upstream passages and a filter that removes foreign substance contain in a liquid is provided between the pressure source and the first and second upstream passages, and
wherein the first upstream passage and the second upstream passage communicate with each other between the pressure source and the filter.

5. The liquid ejection printing apparatus according to claim 1,
wherein a pressure source supplying a liquid at a predetermined pressure is connected to the first and second upstream passages, and the pressure control assembly includes a liquid supply unit with a passage that leads a liquid supplied from the pressure source to the first and second pressure adjustment mechanisms.

6. The liquid ejection printing apparatus according to claim 3,
wherein a pressure source supplying a liquid at a predetermined pressure is connected to the first and second upstream passages, and the filter is provided inside a filter accommodation chamber having an inflow opening connected to the pressure source and an outflow opening connected to the first and second upstream passages, and
wherein the filter accommodation chamber causes a liquid flowing from the inflow opening to pass through the filter and to flow toward the first and second upstream passages from the outflow opening.

7. The liquid ejection printing apparatus according to claim 6,
wherein the inflow opening is provided at a vertical lower portion of the filter accommodation chamber and the outflow opening is provided at a vertical upper portion of the filter accommodation chamber.

8. The liquid ejection printing apparatus according to claim 6,
wherein the filter accommodation chamber includes an exhaust opening that discharges bubbles rising to a lower face of the filter from the filter accommodation chamber.

9. The liquid ejection printing apparatus according to claim 1,
wherein the first pressure adjustment mechanism includes:
a first liquid flow chamber that communicates with the first upstream passage,
a first pressure control chamber that communicates with the first downstream passage,
a first orifice that causes the first liquid flow chamber and the first pressure control chamber to communicate with each other,
a first valve body that changes a passage resistance between the first liquid flow chamber and the first pressure control chamber,
a first urging member that urges the valve body by a first urging force in a direction in which the first orifice is closed, and
a first pressure receiving portion that is displaced on the basis of a change in pressure generated in accordance with a change in amount of a liquid inside the first pressure control chamber and transmits the displacement to the first valve body to operate the first valve body along with the first urging force generated by the first urging member, and
wherein the second pressure adjustment mechanism includes:
a second liquid flow chamber that communicates with the second upstream passage,
a second pressure control chamber that communicates with the second downstream passage,
a second orifice that causes the second liquid flow chamber and the second control pressure chamber to communicate with each other,
a second valve body that changes a passage resistance between the second liquid flow chamber and the second pressure control chamber,
a second urging member that urges the valve body by a second urging force in a direction in which the second orifice is closed, and
a second pressure receiving portion that is displaced on the basis of a change in pressure generated in accordance with a change in amount of a liquid inside the second pressure control chamber and transmits the displacement to the second valve body to operate the second valve body along with the second urging force generated by the second urging member.

10. The liquid ejection printing apparatus according to claim 9,
wherein the first urging force and the second urging force are set to be different from each other.

11. The liquid ejection printing apparatus according to claim 3,
wherein the first urging member includes a first spring seat and a first spring provided between the first spring seat and the first valve body, and
wherein the second urging member includes a second spring seat and a second spring provided between the second spring seat and the second valve body.

12. The liquid ejection printing apparatus according to claim 1,
wherein the liquid ejection head includes
a print element that generates energy for ejecting a liquid from the ejection opening by causing a change in pressure within the pressure chamber, and
a pressure chamber includes the print element therein.

13. The liquid ejection printing apparatus according to claim 12,
wherein the ejection opening communication passage includes an individual supply passage that supplies a liquid to the pressure chamber and an individual collection passage that collects a liquid from the pressure chamber, and
wherein the first downstream passage communicates with the individual supply passage and the second downstream passage communicates with the individual collection passage.

14. The liquid ejection printing apparatus according to claim 9,
wherein a vertical distance between the first orifice and the ejection opening is different from a vertical distance between the second orifice and the ejection opening in a state where the liquid ejection head is used.

15. The liquid ejection printing apparatus according to claim 9,
wherein the first downstream passage communicates with a vertical upper portion of the first pressure control chamber, and
wherein the second downstream passage communicates with a vertical upper portion of the second pressure control chamber.

16. A liquid ejection head that includes an ejection opening ejecting a liquid, the liquid ejection head comprising:
a pressure control assembly that generates a pressure for causing a liquid to flow to an ejection opening communication passage communicating with the ejection opening,
wherein the pressure control assembly includes:
a first upstream passage,
a first pressure adjustment mechanism that causes a liquid supplied from a first upstream passage to flow therefrom at a first pressure,
a second upstream passage,
a second pressure adjustment mechanism that causes a liquid supplied from a second upstream passage to flow therefrom at a second pressure different from the first pressure,
a first downstream passage that supplies a liquid to the ejection opening communication passage from the first pressure adjustment mechanism, and
a second downstream passage that supplies a liquid to the ejection opening communication passage from the second pressure adjustment mechanism,
wherein the first upstream passage and the second upstream passage communicate with each other, and
wherein the first downstream passage and the second downstream passage are respectively connected to the same ejection opening communication passage.

17. The liquid ejection head according to claim 16,
wherein the first upstream passage and the second upstream passage communicate with each other within the pressure control assembly.

18. The liquid ejection head according to claim 16,
wherein a pressure source supplying a liquid at a predetermined pressure is connected to the first and second upstream passages and a filter that removes foreign substance contained in a liquid is provided between the pressure source and the first and second upstream passages, and
wherein the first upstream passage and the second upstream passage communicate with each other between the filter and the first and second pressure control mechanisms.

19. The liquid ejection head according to claim 16,
wherein a pressure source supplying a liquid at a predetermined pressure is connected to the first and second upstream passages and a filter that removes foreign substance contained in a liquid is provided between the pressure source and the first and second upstream passages, and
wherein the first upstream passage and the second upstream passage communicate with each other between the pressure source and the filter.

20. The liquid ejection head according to claim 16,
wherein the liquid ejection head comprises a print element generating energy for ejecting liquid, and a pressure chamber including the print element therein, and
wherein liquid in the pressure chamber is circulated between outside and the pressure chamber.
